(19) United States
(12) Patent Application Publication
(10) Pub. No.: US 2026/0270188 A1
(43) Pub. Date: Sep. 10, 2026

(54) SYSTEMS AND METHODS FOR ENHANCING DISCOVERY OF NETWORK DEVICES WITHIN A COMPUTING ENVIRONMENT

(71) Applicant: Guardare, Inc., Clearwater, FL (US)

(72) Inventors: Thomas Dane Fiori, JR., Clearwater, FL (US); Charles Warren Mitchell, Clearwater, FL (US)

(73) Assignee: Guardare, Inc., Clearwater, FL (US)

(21) Appl. No.: 19/560,506

(22) Filed: Mar. 9, 2026

Related U.S. Application Data
(60) Provisional application No. 63/769,344, filed on Mar. 10, 2025.

(51) Int. Cl. H04L 45/02; H04L 43/10

(52) U.S. Cl. CPC H04L 45/02; H04L 43/10

(57) ABSTRACT

Methods and systems are described herein for enhancing discovery of network devices within computing environments and facilitating remedial actions are disclosed. The system can execute first and second instances of a network discovery agent on respective devices to transmit trace-route type probes between them. The system can determine network address translation at a router based on changes in network addresses received in probe headers. The system can identify intermediate hops between each device and the router from the trace-route sequences. The system can generate a network topology based on the intermediate hops and router. Using the network topology, the system can generate a graph data structure comprising nodes corresponding to network security framework controls and devices. The system can generate remedial actions for addressing security risk using edges between the nodes.

### CROSS-REFERENCE TO RELATED APPLICATIONS

This application claims the benefit of priority to U.S. Provisional Application No. 63/769,344, filed Mar. 10, 2025, the entirety of which is incorporated by reference herein.

### BACKGROUND

Network discovery tools can map devices, services, and communication paths within a computing environment using active probing or passive traffic capture. However, such tools are limited in environments implementing network address translation (NAT), as NAT rewrites packet headers and obscures internal addressing, preventing accurate identification of underlying network structures. As a result, existing systems may fail to detect hidden devices, overlook asymmetric routing paths, and lack automated mechanisms for translating discovery results into actionable security or compliance insights.

### SUMMARY

This disclosure relates to techniques for accurately discovering and mapping network topologies within computing environments via coordinating probing between network discovery agents and data packet capturing to generate remedial actions to reduce cybersecurity risk within the computing environments. Existing network scanning tools are limited in their ability to detect NAT and generate an accurate topology because they operate from a single perspective, often relying solely on active probing or packet capture from a single node, and do not compare probe headers across devices to identify translation of source addresses or ports by intermediate routers. The nature of NAT, by design, rewrites packet header fields and obscures the underlying internal addressing scheme, preventing existing tools from accurately determining the true structure of the network and the identity of internal devices. Furthermore, even when network topology information is obtained, existing systems often fail to automatically reconcile conflicting representations between traceroute-derived hop lists and routing tables, and do not automatically map discovered devices or vulnerabilities to specific controls or requirements of multiple network security frameworks. As a result, existing scanning tools provide incomplete topology views, cannot reliably identify devices hidden behind NAT, and do not generate actionable, framework-specific remediation plans to improve the cybersecurity posture of the computing environment.

The techniques described herein provide advantages over existing network scanning tools via coordinated, multi-perspective, network discovery that overcome the above limitations. For example, multiple instances of a network discovery agent can be executed on different devices within the computing environment to exchange probe sequences (e.g., traceroute-type probes) between the devices, capturing both the transmitted headers and the headers as received at the counterpart device. By comparing these header fields, the techniques can detect NAT at intermediate routers and determine address mappings between original and rewritten network identifiers. For example, by executing a first trace-route type sequence from a first instance of a network discovery agent to a second instance and a second trace-route type sequence from the second instance toward the first instance, the techniques can identify intermediate hops from each direction and determine the router at which network address translation occurs by detecting where source addresses or ports in transmitted probe headers differ from those received at the counterpart network discovery agent.

Using one or more obtained routing tables and the intermediate hops, the techniques can leverage the bi-directional probing approach to identify the NAT boundary within the network path to generate a unified network topology that accurately represents the true structure of devices on both sides of the translation point. Furthermore, by using the unified topology, the techniques can generate a graph data structure that includes nodes corresponding to controls or requirements of one or more network security frameworks and nodes corresponding to devices in the topology, with edges representing relationships between compliance controls and discovered devices. The graph data structure can then be processed using a graph neural network to infer relationships between nodes, identify compliance gaps, and generate device-specific remediation actions based on preserved and learned relationships that account for structural and contextual similarities across frameworks. In this way, the techniques described herein can provide an accurate network topology even in the presence of NAT, integrate active and passive discovery data automatically, resolve conflicting topology sources, and generate actionable, framework-specific remediation plans, thereby improving the computing environment's cybersecurity posture before a cybersecurity attack.

At least one aspect relates to a system. The system can include memory and one or more processors configured by machine-readable instructions stored in the memory to perform one or more operations. The system can execute a first instance of a network discovery agent on a first device of a computing environment to transmit first one or more probes to a second instance of the network discovery agent on a second device of the computing environment. The first one or more probes comprise a first trace-route type sequence and include a first network address of the first device. The system can execute a second instance of the network discovery agent on the second device to transmit second one or more probes to the first instance of the network discovery agent on the first device. The second one or more probes comprise a second trace-route type sequence and include a second network address of the second device. The system can determine a network address translation at a router between the first device and the second device based at least on a change in the first network address received in a header of a first probe at the second device or the second network address received in a header of a second probe at the first device. The system can identify, from the first trace-route type sequence, first one or more intermediate hops between the first device and the router, and, from the second trace-route type sequence, second one or more intermediate hops between the second device and the router. The system can generate a network topology for the computing environment based at least on the first one or more intermediate hops, the router, and the second one or more intermediate hops. The system can generate, using the network topology, a graph data structure comprising a first set of nodes corresponding to controls or requirements of one or more network security frameworks and a second set of nodes corresponding to different devices of the network topology. The system can generate, using edges between the first and second sets of nodes of the graph data structure, a remedial action for addressing security risk from a network security framework of a device within the computing environment.

In some implementations, the system can execute the first instance of the network discovery agent on the first device to transmit a first message to the second instance of the network discovery agent and execute the second instance of the network discovery agent on the second device to transmit a second message to the first instance of the network discovery agent. In some implementations, the system can execute the first instance of the network discovery agent on the first device to transmit the first one or more probes to the second instance of the network discovery agent on the second device in response to determining the second instance of the network discovery agent received the first message and the first instance of the network discovery agent received the second message.

In some implementations, the system can retrieve a routing table from the router identified from the first one or more probes or the second one or more probes. In some implementations, the system can generate the network topology based at least on the routing table in combination with the first one or more intermediate hops and the second one or more intermediate hops.

In some implementations, the system can generate the network topology by addressing one conflict between the network topology generated from the first one or more intermediate hops and the second one or more intermediate hops and the routing table by providing priority to the first one or more intermediate hops and the second one or more intermediate hops.

In some implementations, the system can execute a graph neural network, using the graph data structure to infer one or more relationships represented by the edges between the first set of nodes and the second set of nodes.

In some implementations, the system can determine the network address translation by comparing at least one header field of the first probe as transmitted by the first device to a corresponding header field of the first probe as received at the second device, the header field comprising at least one of a source address or a source port. In some implementations, the system can further determine the network address translation by determining the network address translation in response to determining the comparison indicating the compared header fields do not match.

In some implementations, the first trace-route type sequence and the second trace-route type sequence each comprise transmitting a plurality of probes having successively varied time-to-live values to elicit responses from intermediate hops. In some implementations, the system can identify the intermediate hops based on addresses included in the responses.

In some implementations, the system can map a changed network address observed in a header of a received probe to a corresponding original network address transmitted by the first instance or the second instance. In some implementations, the system can represent the mapped addresses as a single device within the generated network topology.

In some implementations, the system can capture one or more network packets at least one of the first device or the second device, where the captured one or more network packets not addressed to the device at which the one or more network packets were captured. In some implementations, the system can identify a destination address of the one or more network packets. In some implementations, the system can update the network topology to include a link between the device at which the one or more network packets were captured and the destination address. In some implementations, the system can update the graph data structure based on the updated network topology.

In some implementations, the system can generate the graph data structure using the network topology by generating nodes representing each device represented in the network topology. In some implementations, the system can further generate the graph data structure using the network topology by generating first edges between first pairs of the nodes represented based on the first one or more intermediate hops between the first device and the router and second edges between second pairs of the nodes represented based on the second one or more intermediate hops between the second device and the router.

At least one other aspect relates to a method. The method can be performed, for example, by one or more processors coupled to non-transitory memory. The method can include executing a first instance of a network discovery agent on a first device of a computing environment to transmit first one or more probes to a second instance of the network discovery agent on a second device of the computing environment. The first one or more probes comprise a first trace-route type sequence and include a first network address of the first device. The method can include executing a second instance of the network discovery agent on the second device to transmit second one or more probes to the first instance of the network discovery agent on the first device. The second one or more probes comprise a second trace-route type sequence and include a second network address of the second device. The method can include determining a network address translation at a router between the first device and the second device based at least on a change in the first network address received in a header of a first probe at the second device or the second network address received in a header of a second probe at the first device. The method can include identifying, from the first trace-route type sequence, first one or more intermediate hops between the first device and the router, and, from the second trace-route type sequence, second one or more intermediate hops between the second device and the router. The method can include generating a network topology for the computing environment based at least on the first one or more intermediate hops, the router, and the second one or more intermediate hops. The method can include generating, using the network topology, a graph data structure comprising a first set of nodes corresponding to controls or requirements of one or more network security frameworks and a second set of nodes corresponding to different devices of the network topology. The method can include generating, using edges between the first and second sets of nodes of the graph data structure, a remedial action for addressing security risk from a network security framework of a device within the computing environment.

In some implementations, the method can include executing the first instance of the network discovery agent on the first device to transmit a first message to the second instance of the network discovery agent and executing the second instance of the network discovery agent on the second device to transmit a second message to the first instance of the network discovery agent. In some implementations, the method can include executing the first instance of the network discovery agent on the first device to transmit the first one or more probes to the second instance of the network discovery agent on the second device in response to determining the second instance of the network discovery agent received the first message and the first instance of the network discovery agent received the second message.

In some implementations, the method can include retrieving a routing table from the router identified from the first one or more probes or the second one or more probes. In some implementations, the method can include generating the network topology based at least on the routing table in combination with the first one or more intermediate hops and the second one or more intermediate hops.

In some implementations, the method can include generating the network topology by addressing one conflict between the network topology generated from the first one or more intermediate hops and the second one or more intermediate hops and the routing table by providing priority to the first one or more intermediate hops and the second one or more intermediate hops.

In some implementations, the method can include executing a graph neural network, using the graph data structure to infer one or more relationships represented by the edges between the first set of nodes and the second set of nodes.

In some implementations, the method can include determining the network address translation by comparing at least one header field of the first probe as transmitted by the first device to a corresponding header field of the first probe as received at the second device, the header field comprising at least one of a source address or a source port. In some implementations, the method can include further determining the network address translation by determining the network address translation in response to determining the comparison indicating the compared header fields do not match.

In some implementations, the first trace-route type sequence and the second trace-route type sequence each comprise transmitting a plurality of probes having successively varied time-to-live values to elicit responses from intermediate hops. In some implementations, the method can include identifying the intermediate hops based on addresses included in the responses.

In some implementations, the method can include mapping a changed network address observed in a header of a received probe to a corresponding original network address transmitted by the first instance or the second instance. In some implementations, the method can include represent the mapped addresses as a single device within the generated network topology.

In some implementations, the method can include capturing one or more network packets at least one of the first device or the second device, where the captured one or more network packets not addressed to the device at which the one or more network packets were captured. In some implementations, the method can include identifying a destination address of the one or more network packets. In some implementations, the method can include updating the network topology to include a link between the device at which the one or more network packets were captured and the destination address. In some implementations, the method can include updating the graph data structure based on the updated network topology.

In some implementations, the method can include generating the graph data structure using the network topology by generating nodes representing each device represented in the network topology. In some implementations, the method can include further generating the graph data structure using the network topology by generating first edges between first pairs of the nodes represented based on the first one or more intermediate hops between the first device and the router and second edges between second pairs of the nodes represented based on the second one or more intermediate hops between the second device and the router.

At least one other aspect relates to one or more non-transitory computer-readable media. The non-transitory computer-readable media can store instructions that, when executed by one or more processors, cause the one or more processors to perform operations. The operations can include executing a first instance of a network discovery agent on a first device of a computing environment to transmit first one or more probes to a second instance of the network discovery agent on a second device of the computing environment. The first one or more probes comprise a first trace-route type sequence and include a first network address of the first device. The operations can include executing a second instance of the network discovery agent on the second device to transmit second one or more probes to the first instance of the network discovery agent on the first device. The second one or more probes comprise a second trace-route type sequence and include a second network address of the second device. The operations can include determining a network address translation at a router between the first device and the second device based at least on a change in the first network address received in a header of a first probe at the second device or the second network address received in a header of a second probe at the first device. The operations can include identifying, from the first trace-route type sequence, first one or more intermediate hops between the first device and the router, and, from the second trace-route type sequence, second one or more intermediate hops between the second device and the router. The operations can include generating a network topology for the computing environment based at least on the first one or more intermediate hops, the router, and the second one or more intermediate hops. The operations can include generating, using the network topology, a graph data structure comprising a first set of nodes corresponding to controls or requirements of one or more network security frameworks and a second set of nodes corresponding to different devices of the network topology. The operations can include generating, using edges between the first and second sets of nodes of the graph data structure, a remedial action for addressing security risk from a network security framework of a device within the computing environment.

In some implementations, the operations can include executing the first instance of the network discovery agent on the first device to transmit a first message to the second instance of the network discovery agent and executing the second instance of the network discovery agent on the second device to transmit a second message to the first instance of the network discovery agent. In some implementations, the operations can include executing the first instance of the network discovery agent on the first device to transmit the first one or more probes to the second instance of the network discovery agent on the second device in response to determining the second instance of the network discovery agent received the first message and the first instance of the network discovery agent received the second message.

In some implementations, the operations can include retrieving a routing table from the router identified from the first one or more probes or the second one or more probes. In some implementations, the operations can include generating the network topology based at least on the routing table in combination with the first one or more intermediate hops and the second one or more intermediate hops.

In some implementations, the operations can include generating the network topology by addressing one conflict between the network topology generated from the first one or more intermediate hops and the second one or more intermediate hops and the routing table by providing priority to the first one or more intermediate hops and the second one or more intermediate hops.

In some implementations, the operations can include executing a graph neural network, using the graph data structure to infer one or more relationships represented by the edges between the first set of nodes and the second set of nodes.

In some implementations, the operations can include determining the network address translation by comparing at least one header field of the first probe as transmitted by the first device to a corresponding header field of the first probe as received at the second device, the header field comprising at least one of a source address or a source port. In some implementations, the operations can include further determining the network address translation by determining the network address translation in response to determining the comparison indicating the compared header fields do not match.

In some implementations, the first trace-route type sequence and the second trace-route type sequence each comprise transmitting a plurality of probes having successively varied time-to-live values to elicit responses from intermediate hops. In some implementations, the operations can include identifying the intermediate hops based on addresses included in the responses.

In some implementations, the operations can include mapping a changed network address observed in a header of a received probe to a corresponding original network address transmitted by the first instance or the second instance. In some implementations, the operations can include represent the mapped addresses as a single device within the generated network topology.

In some implementations, the operations can include capturing one or more network packets at least one of the first device or the second device, where the captured one or more network packets not addressed to the device at which the one or more network packets were captured. In some implementations, the operations can include identifying a destination address of the one or more network packets. In some implementations, the operations can include updating the network topology to include a link between the device at which the one or more network packets were captured and the destination address. In some implementations, the operations can include updating the graph data structure based on the updated network topology.

In some implementations, the operations can include generating the graph data structure using the network topology by generating nodes representing each device represented in the network topology. In some implementations, the operations can include further generating the graph data structure using the network topology by generating first edges between first pairs of the nodes represented based on the first one or more intermediate hops between the first device and the router and second edges between second pairs of the nodes represented based on the second one or more intermediate hops between the second device and the router.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3A is an illustration of an example system for facilitating remedial actions to cybersecurity vulnerabilities, in accordance with an implementation.

FIG. 3B illustrates an example graph data structure, in accordance with an implementation.

FIG. 3C illustrates an example subgraph data structure of the example graph data structure of FIG. 3B, in accordance with an implementation.

FIG. 4A is an illustration of an example subsystem to enhance discovery of network devices within computing environments, in accordance with an implementation.

FIG. 4B illustrates an example flowchart of a process for facilitating remedial actions to cybersecurity vulnerabilities based on enhanced discovery of network devices within computing environments, in accordance with an implementation.

### DETAILED DESCRIPTION

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes a computing device and graph data structures used for generating remedial actions for cyber security vulnerabilities, in accordance with embodiments described herein.
Section D describes systems and methods for enhanced discovery of network devices and facilitating remedial actions to cybersecurity vulnerabilities, in accordance with embodiments described herein.

### A. Computing and Network Environment

Prior to discussing the specifics of embodiments of facilitating remedial actions to cybersecurity vulnerabilities, it may be helpful to discuss the computing environments in which such embodiments may be deployed.

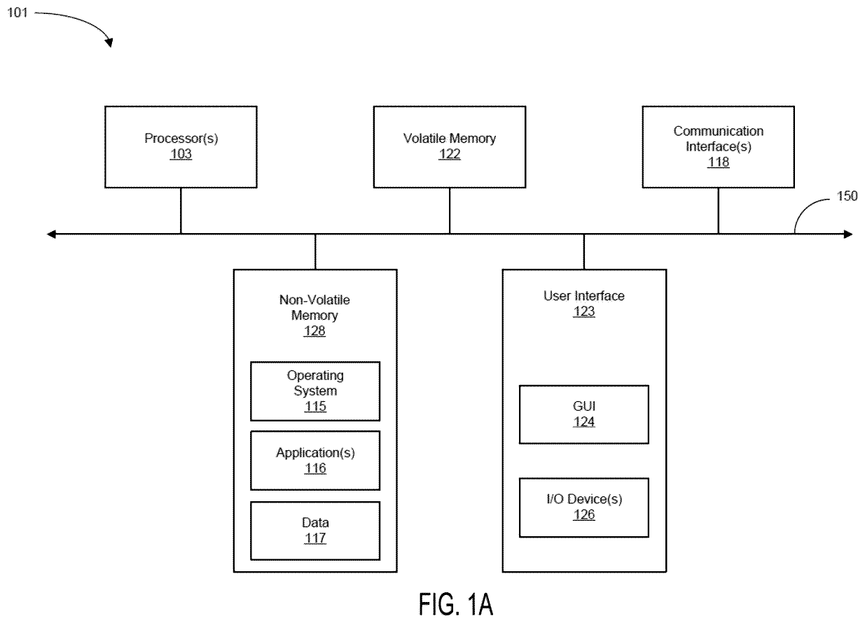

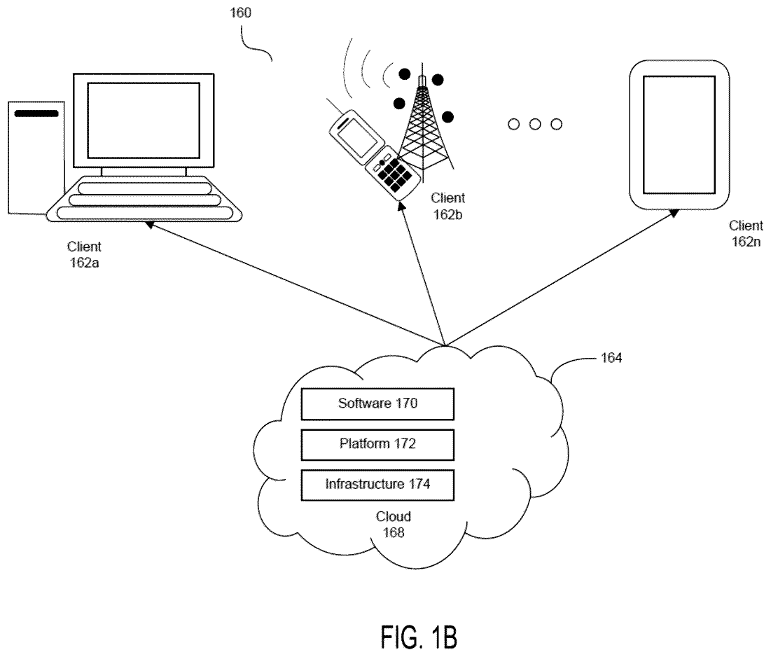

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 160 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g., Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce. com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

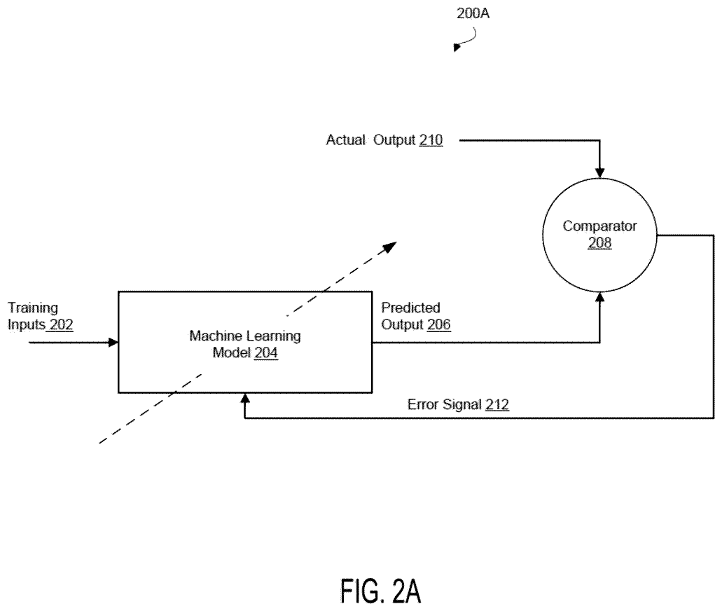

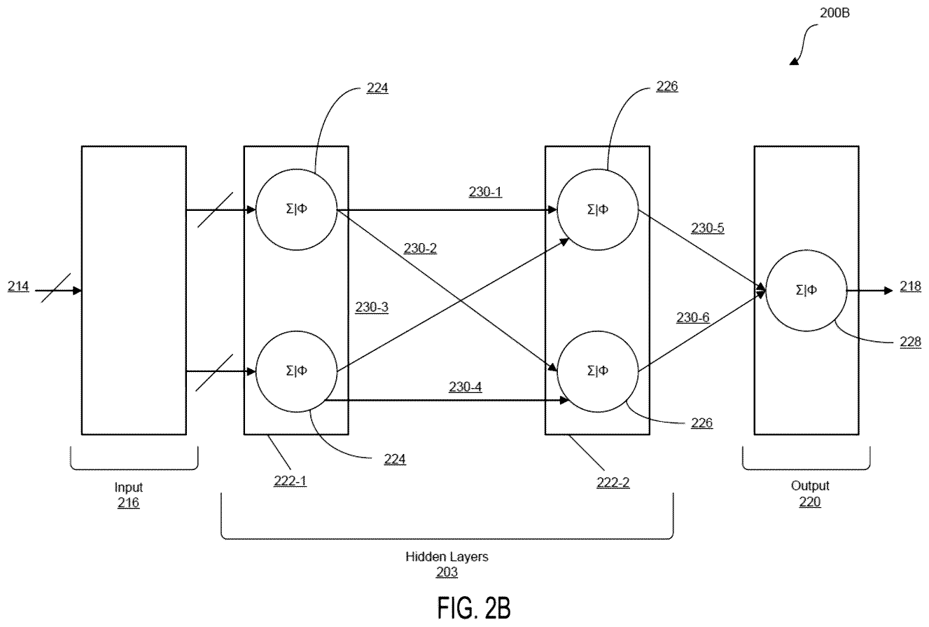

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, deep learning models, reinforcement learning models, unsupervised models, decision trees, support-vector machines, Bayesian networks, Gaussian processes, genetic algorithms models, generative models, image and text processing models, video processing models, any other models that can be used by one or more machine learning algorithms, any other models that can learn from data (e.g., training data) to perform tasks without explicit instructions, or various combinations thereof. They can also involve combinations of the above and agentic systems that leverage models and underlying data. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs), graph neural networks (GNNs), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations).

The training data can include data describing network security frameworks, controls or requirements of network security frameworks, computing environment objects (e.g., firewalls, routers, servers, load balancers, etc.), graphical data (e.g., graph data structures, etc.), network security threats, network security vulnerabilities, networking tactics, configuration profiles of computing environment objects, remedial actions, confidence scores of remedial actions, relationships between controls or requirements of network security frameworks and computing environment objects, or other information. The training data can further include network discovery data such as network address information of computing objects (e.g., private network address identifiers, public network address identifiers, translated network address mappings), connected device information, intermediate hop data from trace-route sequences, routing table entries, network topology representations, network address translation detection results, or other information. The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 be trained on known input-output pairs such that the machine learning model 204 can learn how to predict known outputs given known inputs. Once the machine learning model 204 has learned how to predict known input-output pairs, the machine learning model 204 can operate on unknown inputs to predict an output. The machine learning model 204 may correspond to various models described herein, including language models (e.g., large language models), graph neural networks, validation models, or other models configured to process security-related data and generate outputs for facilitating remedial actions to cybersecurity vulnerabilities.

The machine learning model 204 may be trained based on general data and/or granular data (e.g., data based on a specific computing environment, data based on a specific network security framework, etc.) such that the machine learning model 204 may be trained specific to a particular organization's security posture. Different models may be trained using different types of data depending on their respective functions within the system.

Training inputs 202 and actual outputs 210 may be provided to the machine learning model 204. Training inputs 202 may include various types of security-related data depending on the type of model being trained. For example, training inputs 202 may include framework documentation, control specifications, compliance mappings, threat intelligence data, vulnerability assessments, annotated security scenarios, graph data structures, subgraphs, historical subgraphs, relationships between nodes, computing environment object information, remedial actions, confidence scores associated with remedial actions, graph neural network outputs, network discovery data such as network address information of computing objects, connected device information, intermediate hop data from trace-route sequences, routing table entries, network topology representations, network address translation detection results, or other applicable information. The training inputs 202 may include labels indicating function categories, control family designations, framework identifiers, cross-framework mappings, question-answer pairs, or other contextual signals to provide the machine learning model 204 with relevant information during training.

The training inputs 202 and actual outputs 210 may be received from various data repositories, including the vector database 342, the graph database 344, or the system data 350. For example, a data repository may contain labeled datasets including network security framework information, graph data structures, subgraphs, relationships, missing but expected relationships, remedial actions, confidence scores of remedial actions, computing environment objects and characteristics thereof, network discovery data such as network address information of computing objects, connected device information, intermediate hop data from trace-route sequences, routing table entries, network topology representations, network address translation detection results, or other information. Thus, the machine learning model 204 may be trained to predict outcomes based on the training inputs 202 and actual outputs 210 used to train the machine learning model 204. By using various labels and contextual information in conjunction with the training data, the system may provide further contextual information to the machine learning model 204 during the training routine, such that the machine learning model 204 learns to recognize patterns, relationships, and correlations relevant to its designated function.

The actual outputs 210 may be determined based on the type of model being trained and its intended function. For example, actual outputs 210 may include historic data of subgraphs related to different network security frameworks, remedial actions derived from subgraphs, graph neural network output information, confidence scores, indications of relationships or missing but expected relationships, validation determinations, verified network topology maps representing ground truth network structures, confirmed network address translation mappings between original and rewritten addresses, validated intermediate hop sequences from trace-route operations, authoritative routing table entries retrieved from network devices, verified device connectivity relationships indicating which computing objects are connected to which other computing objects, confirmed network address assignments for computing objects including both private and public address identifiers, or other information. In some embodiments, actual outputs 210 may be ground-truth information for training. In some embodiments, the machine learning model 204 may be continuously trained to improve its quality and accuracy in performing its designated function. The machine learning model 204 can take into account various inputs and execute operations to generate predicted outputs 206 (e.g., remedial actions, recommendations, relationships, insights, or other outputs). The actual outputs 210 may then be determined by measuring real-world outcomes, expert feedback, or other validation mechanisms. Metrics such as accuracy, completeness, consistency, and relevance may be considered when evaluating the quality of candidate outputs.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 312 or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., remedial actions, confidence scores, relationships, validation determinations, or other outputs relevant to facilitating remedial actions to cybersecurity vulnerabilities).

In some embodiments, the example system may include one or more machine learning models 204. For example, a first machine learning model 204 may be a large language model trained to generate remedial actions for cybersecurity vulnerabilities based on network security framework information, computing object information, or other information. In some embodiments, the first machine learning model 204 may be a RAG model that is communicatively coupled with one or more databases (e.g., vector database 342, graph database 344, etc.) or one or more retrievers (e.g., retriever 320, graph data retriever 330, etc.) to retrieve information from the one or more databases as context when generating an output (e.g., a remedial action, a recommendation, a response, etc.).

In some embodiments, the first machine learning model 204 may be trained during a first training routine. The first machine learning model 204 may be trained on a set of first training data (e.g., first training inputs 202, first actual outputs 210, etc.). The set of first training data may include first training inputs 202 that indicate network security framework information. The network security framework information may include electronic documents (or chunks thereof) corresponding to different network security frameworks such as NIST, MITRE, NIST CSF, SP 800-53, MITRE ATT&CK, CIS benchmarks, HIPAA, GDPR, SOC 2, or other security framework documents. The network security framework information may include a control identifier, a requirement specification, a function category, a risk assessment, a family classification, or other information associated with the security frameworks. The first training inputs 202 may also include computing object information corresponding to objects within a computing environment. The computing object information may include a type classification indicating a category of the computing object (e.g., firewall, router, server, load balancer), an object identifier (e.g., a particular type, manufacture, or other granular information of the computing object being considered), a state indicating a current configuration or operational status of the computing object, a platform association indicating the computing platform on which the object operates, log information capturing activity or events associated with the computing object, or other information. The first training inputs 202 may further include questions of Q&A pairs to map particular controls to plain-language explanations, scenarios classified by control families or function categories, and graph neural network output data including confidence scores of remedial actions, remedial actions, relationships between nodes, and indications of missing but expected relationships, network discovery data such as network address information of computing objects, connected device information, intermediate hop data from trace-route sequences, routing table entries, network topology representations, network address translation detection results, or other information.

The set of first training data may also include first actual outputs 210 that indicate target remedial actions or recommendations to be generated based on the first training inputs 202. Such first actual outputs 210 may serve as ground truth information for training the first machine learning model 204 and may be labeled with (i) a remedial action identifier (e.g., harden a server, enable multi-factor authentication, update firewall rules, patch a software vulnerability, restrict network access permissions), (ii) a remedial action type (e.g., configuration change, security control adjustment, software update), (iii) a priority level, (iv) an applicable framework identifier indicating the source framework (e.g., NIST CSF, SP 800-53, MITRE ATT&CK, CIS benchmarks, HIPAA, GDPR, SOC 2), (v) a target object type (e.g., firewall, router, server, load balancer), (vi) a compliance gap classification (e.g., missing control, misconfigured control, expected-but-missing edge, expected-but-missing node, unexpected node or edge), (vii) an effectiveness score based on historical success rates, (viii) cross-framework mappings indicating conceptually similar controls that are syntactically different, (ix) answers of the Q&A pairs to map the particular controls to plain-language explanations, (x) verified network topology identifier, (xi) confirmed network address translation mapping identifiers, (xii) hop sequence identifiers, public or private address identifiers, or other labels associated with the remedial actions.

The first machine learning model 204 may be trained during the first training routine using the first training inputs 202 and first actual outputs 210 described above. The set of first training data may be obtained from a model training database or from the system data 350. For example, the data processing system 306 may retrieve the set of first training data from the system data 350 in response to determining the first machine learning model 204 to be trained. During a first training iteration, the first machine learning model 204 may receive first training inputs 202 comprising network security framework information (e.g., a control specification from NIST SP 800-53), computing object information (e.g., a firewall configuration state), network discovery data (e.g., intermediate hop data from trace-route sequences, network address translation detection results, routing table entries), or graph neural network output data (e.g., an indication of a missing but expected relationship between a network security framework control or requirement and a computing object, an indication of a relationship between a network security framework control or requirement and a computing object, etc.). Based on the first training inputs 202, the first machine learning model 204 may generate a first predicted output 206 comprising a predicted remedial action (e.g., update firewall rules to implement the specified control for the computing object). The comparator 208 may compare the predicted remedial action to the target remedial action of the first actual output 210 (e.g., a ground truth remedial action labeled with the remedial action identifier, remedial action type, applicable framework identifier, etc.). Based on the comparison, the comparator 208 may generate an error signal 212 indicating a difference between the predicted remedial action and the target remedial action. The first machine learning model 204 may update one or more configurations (e.g., weighting coefficients, biases, or other parameters) based on the error signal 212 using a backpropagation algorithm to reduce the error. The error signal 212 may be propagated through the algorithmic weights of the first machine learning model 204 such that the weights adapt based on the amount of error, minimizing a loss function (e.g., cross entropy error function) over successive iterations.

During the first training routine, the first machine learning model 204 may learn the relationships between the first training inputs 202 (e.g., network security control information, network security framework identifiers, computing environment object data, graph neural network output information, network discovery data, etc.) and the first actual outputs 210 (e.g., target remedial actions or other targeted data). The first machine learning model 204 may be trained until the error determined at the comparator 208 is within a threshold or a threshold number of iterations have been reached, after which the trained first machine learning model 204 and associated weighting coefficients may be stored in memory 312 for subsequent inference operations.

In some embodiments, the first machine learning model 204 may be fine-tuned during a first fine-tuning training routine. Fine-tune training (or fine-tuning) refers to a training method where a pre-trained (or partially trained) artificial intelligence model, such as a Large Language Model, is adapted for a specific task or use case. For example, fine-tuning may involve providing additional information (e.g., labels, indications of accuracy, evaluation values, prompts, Q&A pairs, annotations, etc.) to a model (e.g., the first machine learning model 204) to generate more accurate, contextualized, domain-specific responses from the model. The data processing system 306 may prepare a first fine-tuning training dataset from network security framework materials, such as NIST CSF and SP 800-53 documents. The first fine-tuning training dataset may include not only raw text from the network security framework documents, but also annotations or Q&A pairs that map particular controls to plain-language explanations, or scenarios classified by control families (e.g., access control, incident response) or function categories (e.g., Identify, Protect, Detect). The first fine-tuning training dataset may further include graph neural network output data, based on the graph neural network processing subgraphs, that may include confidence scores of remedial actions, candidate remedial actions, relationships between network security frameworks and computing objects, indications of missing but expected relationships, network discovery data, connected device information, intermediate hop data from trace-route sequences, routing table entries, network topology representations, network address translation detection results, or other information. These contextual signals enable the machine learning model 204 to learn associations between security framework terminology, computing environment objects, graph-derived relationship information, network discovery information and generated remedial actions.

During fine-tuning, the first machine learning model 204 learns to generate outputs (e.g., remedial actions) that mimic the language and guidance of the network security frameworks. For example, given a prompt about cloud security, the machine learning model 204 may generate a remedial action or other recommendation with references to relevant controls and framework guidance of cloud security for a computing environment and the objects thereof. The system may fine-tune the first machine learning model 204 during a first fine-tuning training routine based on evaluation metrics such as, for example, precision of control references, completeness of recommended safeguards, consistency with framework terminology (e.g., NIST terminology), or others related to evaluating generated remedial actions. In some embodiments, a human evaluator (e.g., an expert) or an automated validation process may evaluate the generated remedial actions or recommendations by providing an evaluation value corresponding to each generated remedial action. The evaluation value may be a numerical value, such as a normalized numerical value according to a given scale (0-1, 0-10, 0-100, etc.), a percentage, or other quantitative metric for measuring accuracy.

In response to receiving the evaluation value, the data processing system 306 may cause one or more configurations (e.g., weights, biases, or other parameters) of the first machine learning model 204 to be updated by determining an error signal 212 between the generated recommendation (e.g., remedial action) and the evaluation value, using a backpropagation algorithm to reduce the error. By doing so, the machine learning model 204 may be further trained (e.g., fine-tuned) using quantitative evaluation metrics to better generate remedial actions aligned with network security frameworks. If the first machine learning model 204 suggests actions that conflict with the network security frameworks or misses key points, the data processing system 306 may iteratively refine the training data and repeat the fine-tuning process. Successful fine-tuning may be indicated by the first machine learning model 204 producing high-quality, network security framework-aligned remedial actions that address cybersecurity vulnerabilities based on multiple network security frameworks and computing environment-specific information.

As another example, a second machine learning model 204 may be a graph neural network model trained to generate outputs related to remedial actions for cybersecurity vulnerabilities. For example, the second machine learning model 204 may generate remedial actions, recommendations, indications of relationships between network security framework information and computing object information, confidence scores of generated remedial actions, or other information. For example, the second machine learning model 204 may be trained during a second training routine. The second machine learning model 204 may be trained on a set of second training data (e.g., second training inputs 202, second actual outputs 210, etc.). The set of second training data may include second training inputs 202 that indicate graph-based information.

The graph-based information may include subgraphs, historical subgraphs, main-graphs, or portions thereof corresponding to network security frameworks and computing environment objects. The graphs or subgraphs may include nodes corresponding to network security frameworks, nodes corresponding to computing objects, and edges connecting the nodes of the graphs. The nodes corresponding to network security frameworks may include network security framework information, a vector embedding of a chunk of network security framework information, framework identifiers, control identifiers, function categories, risk assessments, family classifications, or other information. The nodes corresponding to computing objects may include a vector embedding of the computing object, type classifications (e.g., firewall, router, server, load balancer), object identifiers, state information indicating current configurations or operational statuses, platform associations, log information, network discovery information such as network address information, connected device information, intermediate hop data from trace-route sequences, routing table entries, or other information. The edges connecting the nodes of the graphs may include relationship information between the nodes, such as indications of missing but expected relationships between nodes, indications of unexpected nodes or edges within subgraphs, device connectivity relationships indicating which computing objects are connected to which other computing objects, or other information.

The relationship information may indicate associations (i) between network security framework controls or requirements and computing objects within a computing environment or (ii) between one network security framework and other network security framework. For example, a relationship may indicate that a particular firewall object is subject to a NIST SP 800-53 access control requirement specifying network traffic filtering rules. As another example, a relationship may indicate that a server object is associated with a CIS benchmark control requiring specific hardening configurations for the operating system. In another example, a relationship may indicate that a router object is linked to a MITRE ATT&CK technique describing lateral movement tactics that the router configuration should mitigate. As a further example, a relationship may indicate that a load balancer object is connected to a HIPAA requirement mandating encryption of data in transit for protected health information. The relationship information may also indicate that a database server object is associated with a GDPR requirement specifying data protection measures for personal data storage.

The set of second training data may also include second actual outputs 210 that indicate target graph-based outputs to be generated based on the second training inputs 202. Such second actual outputs 210 may serve as ground truth information for training the second machine learning model 204 and may be labeled with (i) candidate remedial actions derived from graph analysis, (ii) confidence scores for the candidate remedial actions, (iii) indications of expected-but-missing edges between nodes of the subgraph, (iv) indications of expected-but-missing nodes within the subgraph, (v) indications of unexpected nodes or edges within the subgraph, (vi) inferred connections between nodes that represent conceptually similar controls that are syntactically different across different security frameworks, (vii) gap identifications indicating compliance gaps in controls or requirements of security frameworks respective to computing objects of a computing environment, (viii) cross-framework relationship mappings, (ix) verified network topology maps representing ground truth network structures, (x) confirmed network address translation mappings between original and rewritten addresses, (xi) validated intermediate hop sequences from trace-route operations, (xii) authoritative routing table entries retrieved from network devices, (xiii) verified device connectivity relationships indicating which computing objects are connected to which other computing objects, (xiv) confirmed network address assignments for computing objects including both private and public address identifiers, or other labels associated with the graph-based outputs.

The second machine learning model 204 may be trained during the second training routine using the second training inputs 202 and second actual outputs 210 described above. The set of second training data may be obtained from a model training database or from the system data 350. For example, the data processing system 306 may retrieve the set of second training data from the system data 350 in response to determining the second machine learning model 204 to be trained. During a second training iteration, the second machine learning model 204 may receive second training inputs 202. Based on the second training inputs 202, the second machine learning model 204 may generate a second predicted output 206 comprising predicted candidate remedial actions, predicted confidence scores for the candidate remedial actions, an indication of an expected-but-missing edge between nodes, predicted network topology representations, predicted network address translation mappings, or other information. The comparator 208 may compare the predicted candidate remedial actions, predicted confidence scores, the expected-but-missing edge predictions, or the predicted network discovery outputs, to the target graph-based outputs of the second actual output 210 (e.g., ground truth candidate remedial actions, ground truth confidence scores, ground truth indications of missing relationships, verified network topology maps, confirmed network address translation mappings, validated intermediate hop sequences, etc.). Based on the comparison, the comparator 208 may generate an error signal 212 indicating a difference between the predicted graph-based outputs and the target graph-based outputs. The second machine learning model 204 may update one or more configurations (e.g., weighting coefficients, biases, or other parameters) based on the error signal 212 using a backpropagation algorithm to reduce the error. The error signal 212 may be propagated through the algorithmic weights of the second machine learning model 204 such that the weights adapt based on the amount of error, minimizing a loss function (e.g., mean squared error function for confidence score prediction, cross entropy error function for relationship classification) over successive iterations.

During the second training routine, the second machine learning model 204 may learn patterns within the subgraphs and infer connections between nodes that may not be explicitly preserved in the subgraph, including connections between conceptually similar controls that are syntactically different across different security frameworks. The second machine learning model 204 may learn to identify gaps in controls or requirements of security frameworks respective to computing objects of a computing environment based on the relationships between the second training inputs 202 (e.g., graph data structures, nodal information including framework identifiers and control identifiers, edge information including relationship associations between framework controls and computing objects, historical subgraph patterns, network discovery data including network address information, intermediate hop data, routing table entries, network topology representations, and network address translation detection results, etc.) and the second actual outputs 210 (e.g., target candidate remedial actions, target confidence scores, target relationship inferences, verified network topology maps, confirmed network address translation mappings, validated intermediate hop sequences, verified device connectivity relationships, etc.). The second machine learning model 204 may be trained until the error determined at the comparator 208 is within a threshold or a threshold number of iterations have been reached, after which the trained second machine learning model 204 and associated weighting coefficients may be stored in memory 312 for subsequent inference operations.

As another example, a third machine learning model 204 may be a validation large language model trained to validate remedial actions and evaluate completeness of remedial actions. For instance, the third machine learning model 204 may be used to validate remedial actions outputted from the first machine learning model 204 or remedial actions derived from the second machine learning model 204 (e.g., the graph neural network). The third machine learning model 204 may be configured to determine whether a remedial action satisfies an acceptance criteria and, responsive to determining that the remedial action is incomplete, automatically trigger one or more actions (e.g., an additional iteration of querying the graph data structure and generating the subgraph to obtain additional controls, requirements, or objects omitted from a prior iteration). In some embodiments, the third machine learning model 204 may be a RAG model that is communicatively coupled with one or more databases (e.g., vector database 342, graph database 344, etc.) or one or more retrievers (e.g., retriever 320, graph data retriever 330, etc.) to retrieve information from the one or more databases as context when generating an output (e.g., a remedial action, a recommendation, a response, etc.).

In some embodiments, the third machine learning model 204 may be trained during a third training routine. The third machine learning model 204 may be trained on a set of third training data (e.g., third training inputs 202, third actual outputs 210, etc.) to train the third machine learning model to validate remedial actions generated by the first machine learning model 204 using graph neural network output data and acceptance criteria. The set of third training data may include third training inputs 202 that indicate graph neural network output information, remedial action information, and acceptance criteria information. The graph neural network output information may include outputs generated by the second machine learning model 204 (e.g., the graph neural network) based on processing subgraphs. The graph neural network output information may include candidate remedial actions generated by the graph neural network, confidence scores for the candidate remedial actions, inferred connections between nodes representing conceptually similar controls that are syntactically different across different security frameworks, and gap identifications indicating compliance gaps in controls or requirements of security frameworks respective to computing objects. The graph neural network output information may further include indications of expected-but-missing edges between nodes, indications of expected-but-missing nodes, indications of unexpected nodes or edges, network topology representations, network address translation detection results, or other information derived from the graph neural network processing.

The remedial action information may include remedial action identifiers, remedial action types (e.g., configuration change, security control adjustment, software update), target object types, applicable framework identifiers, and confidence scores associated with the remedial actions. The acceptance criteria information may include completeness criteria such as coverage of one or more applicable security framework controls identified in the graph neural network outputs, addressing of one or more expected-but-missing edges or nodes identified by the graph neural network, inclusion of remedial actions for each computing object associated with relevant framework controls in the graph neural network outputs, consistency with cross-framework mappings for conceptually similar controls that are syntactically different, alignment with function categories and control families of the applicable security frameworks, and addressing of one or more compliance gaps identified by the graph neural network relative to the computing environment objects.

The set of third training data may also include third actual outputs 210 that indicate target validation determinations to be generated based on the third training inputs 202. Such third actual outputs 210 may serve as ground truth information for training the third machine learning model 204 and may be labeled with (i) a validation determination (e.g., complete, incomplete, partially complete), (ii) a completeness score indicating a degree to which the remedial action addresses the graph neural network outputs, (iii) an identification of missing controls or requirements not addressed by the remedial action, (iv) an identification of computing objects not covered by the remedial action, (v) an identification of expected-but-missing relationships not addressed by the remedial action, (vi) an indication of whether additional iterations are required, (vii) a specification of additional controls, requirements, or objects to be obtained in subsequent iterations, or other labels associated with the validation determinations.

The third machine learning model 204 may be trained during the third training routine using the third training inputs 202 and third actual outputs 210 described above. The set of third training data may be obtained from a model training database or from the system data 350. For example, the data processing system 306 may retrieve the set of third training data from the system data 350 in response to determining the third machine learning model 204 to be trained. During a third training iteration, the third machine learning model 204 may receive third training inputs 202 including graph neural network output information (e.g., outputs generated from the second machine learning model 204), remedial action information (e.g., a remedial action generated by the first machine learning model 204 to update firewall rules based on the graph neural network outputs), acceptance criteria information (e.g., criteria requiring coverage of all access control requirements identified in the graph neural network outputs), or other information. Based on the third training inputs 202, the third machine learning model 204 may generate a third predicted output 206 comprising a predicted validation determination. The comparator 208 may compare the predicted validation determination to the target validation determination of the third actual output 210 (e.g., a ground truth validation determination). Based on the comparison, the comparator 208 may generate an error signal 212 indicating a difference between the predicted validation determination and the target validation determination. The third machine learning model 204 may update one or more configurations (e.g., weighting coefficients, biases, or other parameters) based on the error signal 212 using a backpropagation algorithm to reduce the error. The error signal 212 may be propagated through the algorithmic weights of the third machine learning model 204 such that the weights adapt based on the amount of error, minimizing a loss function (e.g., cross entropy error function for validation classification, mean squared error for completeness scoring) over successive iterations.

During the third training routine, the third machine learning model 204 may learn the relationships between the third training inputs 202 (e.g., graph neural network output information derived from the second machine learning model 204, remedial action information generated by the first machine learning model 204, acceptance criteria information, etc.) and the third actual outputs 210 (e.g., target validation determinations). The third machine learning model 204 may be trained until the error determined at the comparator 208 is within a threshold or a threshold number of iterations have been reached, after which the trained third machine learning model 204 and associated weighting coefficients may be stored in memory 312 for subsequent inference operations.

In some embodiments, the third machine learning model 204 may be fine-tuned during a third fine-tuning training routine to validate remedial actions generated via the first machine learning model 204 using outputs from the second machine learning model 204 (e.g., the graph neural network). The data processing system 306 may prepare a third fine-tuning training dataset from historical validation scenarios, including graph neural network outputs, remedial actions generated by the first machine learning model 204, and expert-labeled validation determinations. The third fine-tuning training dataset may include annotations indicating which remedial actions were determined to be complete or incomplete based on the graph neural network outputs, reasons for incompleteness determinations, and specifications of additional controls, requirements, or objects that were obtained in subsequent iterations to achieve completeness. The third fine-tuning training dataset may further include graph neural network output data such as candidate remedial actions, confidence scores, inferred connections between nodes, and gap identifications to enable the third machine learning model 204 to learn associations between graph neural network-derived information and validation determinations.

During fine-tuning, the third machine learning model 204 learns to evaluate completeness of remedial actions generated by the first machine learning model 204 relative to the graph neural network outputs and determine whether remedial actions satisfy acceptance criteria. For example, given a remedial action generated by the first machine learning model 204 and corresponding graph neural network outputs from the second machine learning model 204, the third machine learning model 204 may generate a validation determination indicating whether the remedial action addresses all applicable controls, requirements, and computing objects identified in the graph neural network outputs. The system may fine-tune the third machine learning model 204 during a third fine-tuning training routine based on evaluation metrics such as, for example, accuracy of completeness determinations relative to graph neural network outputs, precision in identifying missing controls or objects based on the graph neural network-identified gaps, recall in detecting incomplete remedial actions, or others related to evaluating validation determinations. In some embodiments, a human evaluator (e.g., an expert) or an automated validation process may evaluate the validation determinations by providing an evaluation value corresponding to each validation determination. The evaluation value may be a numerical value, such as a normalized numerical value according to a given scale (0-1, 0-10, 0-100, etc.), a percentage, or other quantitative metric for measuring accuracy.

In response to receiving the evaluation value, the data processing system 306 may cause one or more configurations (e.g., weights, biases, or other parameters) of the third machine learning model 204 to be updated by determining an error signal 212 between the generated validation determination and the evaluation value, using a backpropagation algorithm to reduce the error. By doing so, the third machine learning model 204 may be further trained (e.g., fine-tuned) using quantitative evaluation metrics to better evaluate completeness of remedial actions relative to graph neural network outputs. If the third machine learning model 204 incorrectly determines a remedial action to be complete when the graph neural network outputs indicate missing controls or gaps, or incorrectly determines a remedial action to be incomplete when all requirements identified in the graph neural network outputs are addressed, the data processing system 306 may iteratively refine the training data and repeat the fine-tuning process. Successful fine-tuning may be indicated by the third machine learning model 204 producing accurate validation determinations that correctly identify incomplete remedial actions based on graph neural network outputs and trigger additional iterations to obtain omitted controls, requirements, or objects.

In some embodiments, the third machine learning model 204 may be trained on a set of fourth training data to validate remedial actions from the second machine learning model 204 (e.g., the graph neural network) relative to a subgraph. The set of fourth training data may include fourth training inputs 202 that indicate subgraph information, graph neural network output information, remedial action information, and acceptance criteria information. The subgraph information may include the subgraph used as input to the second machine learning model 204 (e.g., the graph neural network), including nodes corresponding to controls or requirements of network security frameworks, nodes corresponding to computing objects of a computing environment, and the edges linking the nodes. The nodes corresponding to network security frameworks may include network security framework information, a vector embedding of a chunk of network security framework information, framework identifiers, control identifiers, function categories, risk assessments, family classifications, or other information. The nodes corresponding to computing objects may include a vector embedding of the computing object, type classifications (e.g., firewall, router, server, load balancer), object identifiers, state information indicating current configurations or operational statuses, platform associations, log information, network discovery data such as network address information of computing objects, connected device information, intermediate hop data from trace-route sequences, routing table entries, or other information. The edges connecting the nodes of the graphs may include relationship information between the nodes, such as indications of missing but expected relationships between nodes, indications of unexpected nodes or edges within subgraphs, device connectivity relationships indicating which computing objects are connected to which other computing objects, or other information. The acceptance criteria information may include completeness criteria such as coverage of one or more applicable security framework controls identified in the graph neural network outputs, addressing of one or more expected-but-missing edges or nodes identified by the graph neural network, inclusion of remedial actions for each computing object associated with relevant framework controls in the graph neural network outputs, consistency with cross-framework mappings for conceptually similar controls that are syntactically different, alignment with function categories and control families of the applicable security frameworks, addressing of one or more compliance gaps identified by the graph neural network relative to the computing environment objects, or other acceptance criteria.

The graph neural network output information may further include indications of expected-but-missing edges between nodes of the subgraph, indications of expected-but-missing nodes within the subgraph, indications of unexpected nodes or edges within the subgraph, network topology representations, network address translation detection results, or other information derived from the graph neural network processing of the subgraph. The remedial action information may include remedial action identifiers, remedial action types (e.g., configuration change, security control adjustment, software update), target object types, applicable framework identifiers, and confidence scores associated with the remedial actions derived from the second machine learning model 204.

The set of fourth training data may also include fourth actual outputs 210 that indicate target validation determinations for the graph neural network outputs relative to the subgraph and the acceptance criteria. Such fourth actual outputs 210 may serve as ground truth information for training the third machine learning model 204 and may be labeled with (i) a validation determination (e.g., complete, incomplete, partially complete) indicating whether the candidate remedial actions adequately address the relationships and gaps identified in the subgraph and satisfy the acceptance criteria, (ii) a completeness score indicating a degree to which the remedial actions address the nodes, edges, and relationships within the subgraph relative to the acceptance criteria, (iii) an identification of nodes corresponding to network security frameworks from the subgraph not addressed by the remedial actions, (iv) an identification of nodes corresponding to computing objects from the subgraph not covered by the remedial actions, (v) an identification of edges or relationships within the subgraph not addressed by the remedial actions, (vi) an indication of whether additional iterations are required to expand the subgraph based on the acceptance criteria evaluation, (vii) a specification of additional controls, requirements, or objects to be obtained in subsequent iterations based on the subgraph analysis and acceptance criteria, (viii) verified network topology identifier, (ix) confirmed network address translation mapping identifiers, (x) hop sequence identifiers, public or private address identifiers, or other labels associated with the validation determinations relative to the subgraph and acceptance criteria.

The third machine learning model 204 may be trained during a fourth training routine using the fourth training inputs 202 and fourth actual outputs 210 described above. The set of fourth training data may be obtained from a model training database or from the system data 350. For example, the data processing system 306 may retrieve the set of fourth training data from the system data 350 in response to determining the third machine learning model 204 to be trained for validating graph neural network outputs relative to subgraphs and acceptance criteria. During a fourth training iteration, the third machine learning model 204 may receive fourth training inputs 202 including subgraph information (e.g., the subgraph including nodes corresponding to network security frameworks and nodes corresponding to computing objects with their associated edges), graph neural network output information (e.g., candidate remedial actions and confidence scores generated by the second machine learning model 204 based on processing the subgraph), remedial action information (e.g., a candidate remedial action to update firewall rules derived from the graph neural network analysis of the subgraph), and acceptance criteria information (e.g., criteria requiring coverage of all access control requirements identified in the graph neural network outputs). Based on the fourth training inputs 202, the third machine learning model 204 may generate a fourth predicted output 206 comprising a predicted validation determination indicating whether the candidate remedial actions adequately address the subgraph and satisfy the acceptance criteria. The comparator 208 may compare the predicted validation determination to the target validation determination of the fourth actual output 210 (e.g., a ground truth validation determination relative to the subgraph and acceptance criteria). Based on the comparison, the comparator 208 may generate an error signal 212 indicating a difference between the predicted validation determination and the target validation determination. The third machine learning model 204 may update one or more configurations (e.g., weighting coefficients, biases, or other parameters) based on the error signal 212 using a backpropagation algorithm to reduce the error. The error signal 212 may be propagated through the algorithmic weights of the third machine learning model 204 such that the weights adapt based on the amount of error, minimizing a loss function (e.g., cross entropy error function for validation classification, mean squared error for completeness scoring relative to subgraph coverage and acceptance criteria satisfaction) over successive iterations.

During the fourth training routine, the third machine learning model 204 may learn the relationships between the fourth training inputs 202 (e.g., subgraph information including nodes corresponding to network security frameworks and nodes corresponding to computing objects, graph neural network output information derived from the second machine learning model 204 processing the subgraph, remedial action information, acceptance criteria information, network discovery data such as network address information, intermediate hop data, routing table entries, network topology representations, and network address translation detection results, etc.) and the fourth actual outputs 210 (e.g., target validation determinations relative to the subgraph and acceptance criteria, verified network topology maps, confirmed network address translation mappings, validated intermediate hop sequences, verified device connectivity relationships, confirmed network address assignments, etc.). By having direct access to the subgraph and acceptance criteria, the third machine learning model 204 may learn to evaluate whether the candidate remedial actions generated by the second machine learning model 204 adequately address all nodes corresponding to network security frameworks, nodes corresponding to computing objects, and edges within the subgraph, and whether the remedial actions satisfy the acceptance criteria. The third machine learning model 204 may be trained until the error determined at the comparator 208 is within a threshold or a threshold number of iterations have been reached, after which the trained third machine learning model 204 and associated weighting coefficients may be stored in memory 312 for subsequent inference operations involving validation of graph neural network outputs relative to subgraphs and determination of whether remedial actions satisfy the acceptance criteria.

In some embodiments, the third machine learning model 204 may be fine-tuned during a fourth fine-tuning training routine to validate remedial actions generated from the second machine learning model 204 (e.g., the graph neural network) relative to a subgraph. The data processing system 306 may prepare a fourth fine-tuning training dataset from historical validation scenarios, including subgraphs used as input to the second machine learning model 204 (e.g., the graph neural network), graph neural network outputs generated from processing the subgraphs, remedial actions generated from the graph neural network outputs, expert-labeled validation determinations, acceptance criteria, or other information. The fourth fine-tuning training dataset may include the subgraphs with their nodes corresponding to controls or requirements of network security frameworks, nodes corresponding to computing objects of a computing environment, and the edges linking the nodes. The fourth fine-tuning training dataset may include annotations indicating which remedial actions were determined to be complete or incomplete based on the subgraph and the graph neural network outputs, reasons for incompleteness determinations relative to the subgraph structure, and specifications of additional controls, requirements, or objects that were obtained in subsequent iterations to expand the subgraph and achieve completeness. The fourth fine-tuning training dataset may further include acceptance criteria information such as completeness criteria requiring coverage of applicable security framework controls identified in the subgraph, addressing of expected-but-missing edges or nodes identified by the graph neural network, inclusion of remedial actions for each computing object associated with relevant framework controls in the subgraph, and consistency with cross-framework mappings for conceptually similar controls that are syntactically different. The fourth fine-tuning training dataset may also include graph neural network output data such as candidate remedial actions, confidence scores, inferred connections between nodes, and gap identifications, network discovery data such as network address information of computing objects, connected device information, intermediate hop data from trace-route sequences, routing table entries, network topology representations, and network address translation detection results to enable the third machine learning model 204 to learn associations between subgraph structure, graph neural network-derived information, acceptance criteria, and validation determinations.

During fine-tuning, the third machine learning model 204 learns to evaluate completeness of remedial actions generated from the second machine learning model 204 (e.g., the graph neural network) relative to the subgraph and determine whether remedial actions satisfy acceptance criteria. By having direct access to the subgraph, the third machine learning model 204 may learn to evaluate whether the candidate remedial actions adequately address all nodes corresponding to network security frameworks, nodes corresponding to computing objects, and edges within the subgraph. For example, given a subgraph including nodes corresponding to network security frameworks and nodes corresponding to computing objects with their associated edges, graph neural network outputs from the second machine learning model 204 processing the subgraph, and acceptance criteria information, the third machine learning model 204 may generate a validation determination indicating whether the remedial action addresses all applicable controls, requirements, and computing objects identified in the subgraph and whether the remedial action satisfies the acceptance criteria. The system may fine-tune the third machine learning model 204 during a fourth fine-tuning training routine based on evaluation metrics such as, for example, accuracy of completeness determinations relative to subgraph coverage and acceptance criteria satisfaction, precision in identifying nodes corresponding to network security frameworks or nodes corresponding to computing objects from the subgraph not addressed by the remedial actions, recall in detecting incomplete remedial actions based on the subgraph structure, or others related to evaluating validation determinations relative to the subgraph and acceptance criteria. In some embodiments, a human evaluator (e.g., an expert) or an automated validation process may evaluate the validation determinations by providing an evaluation value corresponding to each validation determination. The evaluation value may be a numerical value, such as a normalized numerical value according to a given scale (0-1, 0-10, 0-100, etc.), a percentage, or other quantitative metric for measuring accuracy.

In response to receiving the evaluation value, the data processing system 306 may cause one or more configurations (e.g., weights, biases, or other parameters) of the third machine learning model 204 to be updated by determining an error signal 212 between the generated validation determination and the evaluation value, using a backpropagation algorithm to reduce the error. By doing so, the third machine learning model 204 may be further trained (e.g., fine-tuned) using quantitative evaluation metrics to better evaluate completeness of remedial actions relative to the subgraph and acceptance criteria. If the third machine learning model 204 incorrectly determines a remedial action to be complete when the subgraph and graph neural network outputs indicate missing controls, gaps, or unaddressed nodes or edges, or incorrectly determines a remedial action to be incomplete when all nodes corresponding to network security frameworks, nodes corresponding to computing objects, and edges within the subgraph are addressed and the acceptance criteria are satisfied, the data processing system 306 may iteratively refine the training data and repeat the fine-tuning process. Successful fine-tuning may be indicated by the third machine learning model 204 producing accurate validation determinations that correctly identify incomplete remedial actions based on the subgraph structure and graph neural network outputs, determine whether remedial actions satisfy the acceptance criteria, and trigger additional iterations to expand the subgraph and obtain omitted controls, requirements, or objects.

Referring to FIG. 2B, a block diagram of a simplified neural network model 200B is shown. The neural network model 200B is only an example architecture. The neural network 200B can be any type of neural network, such as a feedforward neural network, a recurrent neural network, a convolutional neural network, a long short-term memory neural network, graph neural network, deep neural network, etc. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier's ability to classify various classes. Other classifiers may be used to make other classifications. For example, the sigmoid function makes binary determinations about the classification of one class (i.e., the output may be classified using label A or the output may not be classified using label A).

### C. Computing Device and Graph Data Structures Used for Generating Remedial Actions to Cyber Security Vulnerabilities

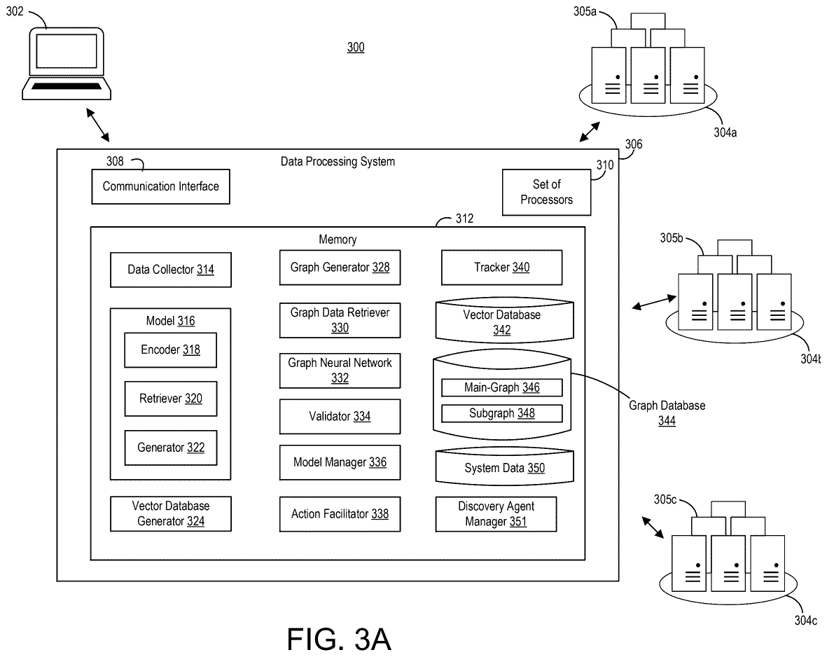

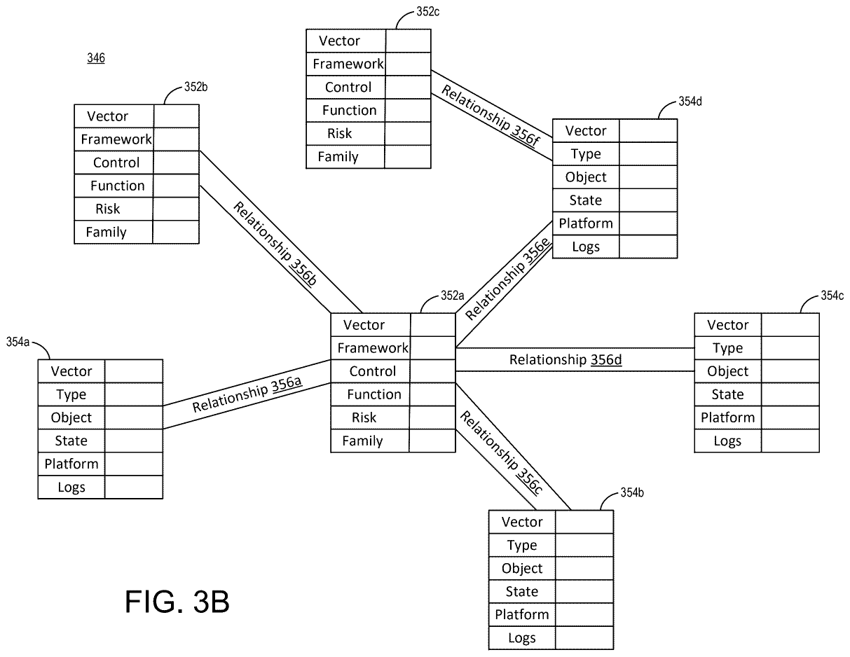

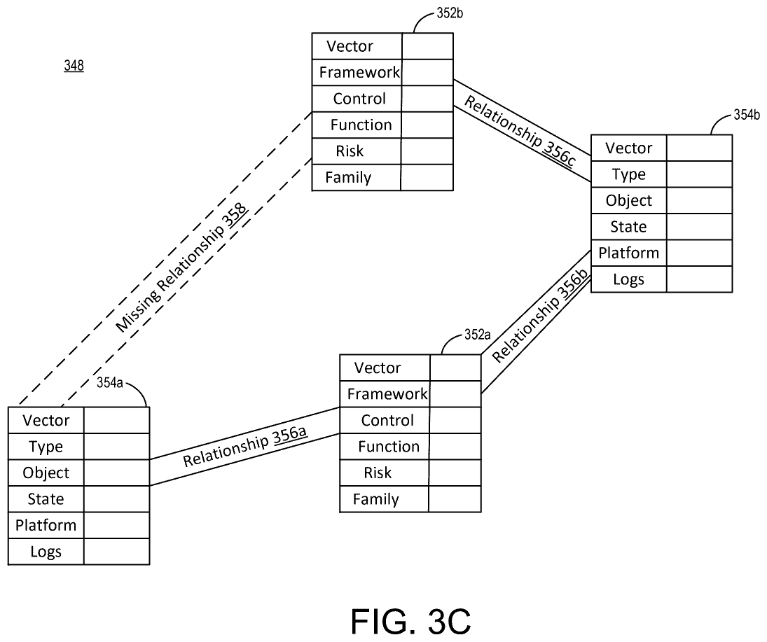

FIG. 3A is an illustration of an example system 300 for facilitating remedial actions to cybersecurity vulnerabilities, in accordance with an implementation. In brief overview, the example system 300 can include a client device 302, computing environments 304a-304c (including one or more computing objects 305a-305c), and a data processing system 306. The system 300 can include more or fewer components than illustrated in FIG. 3A, depending on the implementation. Each of the computing devices can be configured to store various types of data and perform various types of operations discussed in this disclosure. The data processing system 306 can perform one or more operations associated with generating, implementing, revising, or providing remedial actions or other recommendations for cyber security vulnerabilities.

The client device 302 can be an electronic computing device (e.g., a cellular phone, a laptop, a tablet, a personal computer, or any other type of computing device). The client device 302 can include a display with a microphone, a speaker, a keyboard, a touchscreen, or any other type of input/output device. A user can access a platform provided by the data processing system 306 through the client device 302 to interact with one or more models (e.g., LLMs, GNNs, NNs, etc.), view outputs of models (e.g., remedial actions, recommendations, etc.), query databases, view graph data, manage computing environments, view network discovery information, or other user-interface related processes as described herein.

For example, the client device 302 may present a user interface that enables users to submit natural language queries requesting information about different network security frameworks as related to objects of a computing environment. The client device 302 may also receive and display indications of remedial actions generated by the data processing system 306, including recommendations for addressing gaps in controls or requirements of applicable security frameworks with respect to computing objects within the computing environments 304a-304c. Furthermore, the client device 302 may enable users to select which network security frameworks are applicable to their organization and view dynamic reports generated through natural language inputs.

Computing environments 304a-304c may be or correspond to networked computing infrastructures associated with one or more entities, such as organizations, enterprises, or other business units. The computing environments 304a-304c may be managed by cybersecurity experts, information technology administrators, security operations center personnel, or other authorized users responsible for maintaining the security posture of the respective computing environments. For example, a user may manage the computing environments 304a-304c (or computing objects 305a-305c) using client device 302. In other embodiments, the computing environments 304a-304c may be used as information sources to provide information related to real-time (or near real-time) cybersecurity vulnerabilities, computing object 305a-305c information, configuration states, security events, compliance status, or other operational data relevant to generating remedial actions.

Each of the computing environments 304a-304c may include one or more computing objects 305a-305c that represent components, devices, or resources within the respective computing environment. The computing environments 304a-304c may be implemented as on-premises data centers, cloud-based infrastructures, hybrid computing environments, or distributed computing systems spanning multiple geographic locations. The computing environments 304a-304c may be subject to various network security frameworks, compliance requirements, and regulatory standards that govern the configuration and operation of the computing objects 305a-305c within each respective environment. For example, a first computing environment 304a may be associated with a first network security framework such as NIST CSF and a second computing environment 304b may be associated with a second network security framework such as HIPAA or GDPR. As another example, however, a given computing environment 304 may be associated with multiple network security frameworks simultaneously, such as when an organization must comply with both industry-specific regulations (e.g., HIPAA for healthcare data) and general cybersecurity standards (e.g., NIST SP 800-53 for federal information systems). The data processing system 306 can leverage the techniques described herein to identify applicable controls and requirements across these different frameworks and generate remedial actions that address compliance gaps across multiple frameworks concurrently, thereby enabling organizations to maintain a comprehensive security posture that satisfies diverse regulatory and operational requirements.

The computing objects 305a-305c may include, for example, firewalls, routers, switches, servers, load balancers, intrusion detection systems, intrusion prevention systems, endpoint devices, virtual machines, containers, network segments, databases, storage systems, authentication servers, domain controllers, web application firewalls, proxy servers, VPN gateways, computing devices, computers, desktop computers, laptop computers, workstations, personal computers, mobile devices, smartphones, tablets, wearable devices, embedded systems, Internet of Things (IoT) devices, printers, multifunction devices, scanners, network-attached storage (NAS) devices, storage area network (SAN) components, backup systems, modems, gateways, bridges, hubs, repeaters, protocol converters, terminal servers, thin clients, zero clients, kiosks, point-of-sale terminals, programmable logic controllers, building automation systems, security cameras, access control systems, badge readers, biometric authentication devices, voice over IP (VoIP) phones, video conferencing systems, digital signage systems, smart televisions, gaming consoles, streaming devices, network appliances, unified threat management devices, network monitoring tools, packet capture devices, container runtime environments, DNS servers, DHCP servers, key management systems, hardware security modules, or other network infrastructure components, peripheral devices, or computing equipment that may be connected together in a computing network.

As noted above, while only one computing object is shown in FIG. 3A for each computing environment 304, it will be appreciated that each computing environment 304a-304c may include multiple computing objects 305. The computing objects 305a-305c may be configured to transmit real-time data to the data processing system 306, including configuration states, security event logs, vulnerability scan results, compliance assessment data, network traffic patterns, authentication logs, access control configurations, software version information, patch status, and other operational telemetry. The data processing system 306 may receive this real-time data from the computing objects 305a-305c via the communication interface 308 and use the received data to generate remedial actions or other recommendations with current information about the computing environment. By continuously receiving real-time data from the computing objects 305a-305c, the data processing system 306 can generate remedial actions that are tailored to the current state of the computing environment, identify emerging vulnerabilities as they arise, and provide recommendations that account for the specific configurations and operational characteristics of the computing objects 305a-305c. This real-time data integration enables the data processing system 306 to generate context-aware remedial actions that address not only static compliance requirements from network security frameworks but also dynamic security conditions within the computing environments 304a-304c.

The data processing system 306 may include one or more processors that are configured to perform operations associated with generating, implementing, revising, or providing remedial actions or other recommendations for cybersecurity vulnerabilities. The data processing system 306 may include a communication interface 308, a set of processors 310, and a memory 312. The data processing system 306 may communicate with the computing environments 304a-304c, the computing objects 305a-305c, the client device 302, or other components via the communication interface 308, which may be or include an antenna or other network device that enables communication across a network and/or with other devices. The memory 312 may include a data collector 314, a model 316 that includes an encoder 318, a retriever 320, and a generator 322, a vector database generator 324, a graph generator 328, a graph data retriever 330, a graph neural network 332, a validator 334, a model manager 336, an action facilitator 338, a tracker 340, a vector database 342, a graph database 344 that includes a main-graph 346 and subgraph 348, and system data 350, discovery agent manager 351, or other components.

The set of processors 310 may be or include an application-specific integrated circuit (ASIC), a set of field programmable gate arrays (FPGAs), a set of digital signal processors (DSPs), circuits containing one or more processing components, circuitry for supporting a microprocessor, a group of processing components, or other suitable electronic processing components. In some embodiments, the set of processors 310 may execute computer code or modules (e.g., executable code, object code, source code, script code, machine code, etc.) stored in the memory 312 to facilitate the operations described herein. The memory 312 may be or include any volatile or non-volatile computer-readable storage medium capable of storing data or computer code.

One or more of the computing environments 304, computing objects 305, or the data processing system 306 can include or utilize at least one processing unit or other logic devices such as a programmable logic array engine or a module configured to communicate with one another or other resources or databases to perform one or more of the operations described in this disclosure. As described herein, computers can be described as computers, computer devices, computing devices, or client devices. One or more of the computing environments 304 or computing objects 305 may each contain their own computer resources (e.g., processor, memory, etc.), share computer resources, or be part of a distributed computer system. The components of the computing environments 304, computing objects 305, or the data processing system 306 can be separate components or a single component. The example system 300 and its components can include hardware elements, such as one or more processors, logic devices, or circuits. One or more of the computing environments 304, computing objects 305, or the data processing system 306 can each store information in memory (e.g., in a database in memory), where such media may include non-transitory machine-readable media used to store program instructions for performing one or more operations described in this disclosure.

The data collector 314 may include instructions that, when executed by the set of processors 310, cause the set of processors 310 to aggregate and retrieve or receive data from different sources, such as the computing environments 304a-304c, the computing objects 305a-305c, the client device 302, the Internet, databases, network security framework administrators, entities, or organizations.

For example, the data collector 314 may access the Internet via the communication interface 308 to retrieve or receive electronic documents corresponding to network security frameworks. The electronic documents corresponding to network security frameworks may provide a structured approach for managing and reducing cybersecurity risk of one or more computing environments 304 or one or more computing objects 305. Such electronic documents may correspond to different network security frameworks. The electronic documents corresponding to the network security frameworks may be pushed from network security framework administrators (e.g., NITS, MITRE, etc.), security advisory entities, or other cybersecurity organizations. Such administrators, entities, or other organizations may push updated network security framework information to data collector 314, such as updated guidance documents, control specifications, or security advisories (e.g., NIST publishing updates to SP 800-53 controls, MITRE releasing new ATT&CK techniques, or CIS publishing revised benchmark configurations). The data collector 314 may perform such operations by implementing various retrieval methods such as polling, change data capture (CDC), webhook subscriptions, or event-driven mechanisms to fetch real-time data updates from administrators, entities, or other organizations. For example, the data collector 314 employ message queues such as Apache Kafka or RabbitMQ to buffer incoming data streams and prevent data loss during high-volume periods.

In some embodiments, the data collector 314 may identify the electronic documents corresponding to network security frameworks. The data collector 314 may identify electronic documents based on document identifiers, metadata tags, file naming conventions, header information, or source information indicating the associated network security framework (e.g., NIST CSF, SP 800-53, MITRE ATT&CK, CIS benchmarks, HIPAA, GDPR, SOC 2). In some embodiments, the data collector 314 may apply natural language processing techniques, such as text classification models trained on labeled network security framework documents, to classify documents according to their corresponding network security frameworks. By identifying the electronic documents corresponding to network security frameworks, the data collector 314 can ensure accurate categorization and indexing of the documents within the system data 350, thereby facilitating efficient retrieval of framework-specific information during subsequent processing operations.

As another example, the data collector 314 may retrieve or receive computing object data from the computing objects 305a-305c and computing environments 304a-304c. For example, the data collector 314 may establish persistent connections with the computing objects 305a-305c using protocols such as WebSockets, gRPC streaming, MQTT, or other pushed or pulled data protocols to receive computing object data from the computing objects 305a-305c. The computing object data may include event logs, configuration profiles, vulnerability scan results, authentication logs, network traffic information, routing tables, compliance assessment data, access control lists, firewall rules, intrusion detection alerts, software version information, state information, platform information, patch installation status, certificate expiration notifications, user privilege escalation events, failed login attempts, port scanning activity, malware detection alerts, system resource utilization metrics, backup completion status, encryption key rotation events, API access logs, session timeout events, geolocation data, assigned Internet Protocol or other communication address information, timestamps corresponding to the computing object data, device health attestation results, identity and access management data, user permissions, product information, function information, network segmentation configurations, OS-level patch management data, security policy configurations, or other data of one or more computing objects 305a-305c.

Such protocols may push computing object data from the computing objects 305a-305c to the data collector 314 via one or more streamed processing frameworks to ingest and process real-time data feeds. The data collector 314 may receive push notifications from the computing objects 305a-305c when configuration changes occur, security events are detected, or compliance status changes, enabling the data processing system 306 to maintain current awareness of the security posture of the computing environments 304a-304c. In other embodiments, however, such protocols may be configured for data collector 314 to pull computing object data from the computing objects 305a-305c or the computing environments 304a-304c therein. For example, data collector 314 may be configured to pull computing object data from the computing objects 305a-305c according to scheduled time intervals.

The data collector 314 may store the collected data within the system data 350 in a structured manner, enabling efficient indexing, querying, and retrieval of information. For example, the data collector 314 may store the collected data in system data 350. By continuously collecting real-time data from the computing objects 305a-305c and computing environments 304a-304c, the data collector 314 enables the data processing system 306 to generate remedial actions based on current security conditions rather than relying on stale or outdated information, thereby improving the accuracy and relevance of generated recommendations compared to existing systems that rely on periodic batch processing or manual data collection.

In some embodiments, the collected data (or portions thereof) may be stored in the vector database 342 when the data processing system 306 generates the respective vector database 342, in accordance with one or more implementations described herein. For example, the data collector may include instructions that, when executed by the set of processors 310, cause the set of processors 310 to provide the electronic documents corresponding to the network security frameworks to the encoder 318 to generate embeddings corresponding to the electronic documents. For instance, in response to the data collector 314 collecting the electronic documents corresponding to network security frameworks, the data collector may provide the collected electronic documents (or portions thereof) to the encoder 318 to generate embeddings corresponding to the electronic documents. The encoder 318 may be the encoder of the model 316 (e.g., the first machine learning model, the large language model configured to generate remedial actions, etc.). Using the encoder 318 of the model 316 to generate embeddings for the vector database 342 is advantageous, as the model 316 may retrieve documents from the vector database 342 during inference operations. In this way, using the same encoder 318 preserves embedding space characteristics and ensures semantic consistency between the embeddings stored in the vector database 342 and the embeddings generated from input queries during retrieval operations.

In some embodiments, the electronic documents corresponding to the network security frameworks may be chunked prior to embedding generation. For example, to facilitate RAG techniques via model 316 using the electronic documents, the data collector 314 may include instructions that, when executed by the set of processors 310, cause the set of processors 310 to invoke the encoder 318 to chunk the electronic documents into one or more chunks and generate corresponding embeddings to be stored in the vector database 342.

The encoder 318 may include instructions that, when executed by the set of processors 310, cause the set of processors 310 to apply a chunking technique to segment the electronic documents corresponding to the network security frameworks into smaller portions (e.g., document chunks) suitable for embedding generation. For example, the chunking technique may segment the electronic documents based on semantic boundaries, paragraph structures, control specifications, or fixed token lengths to produce document chunks that preserve contextual meaning while conforming to input size constraints of the encoder 318. The encoder 318 may include instructions that, when executed by the set of processors 310, cause the set of processors 310 to process each document chunk to generate a corresponding embedding, which is a dense vector representation that captures the semantic content of the document chunk in a high-dimensional vector space.

The encoder 318 may include instructions that, when executed by the set of processors 310, cause the set of processors 310 to invoke the vector database generator 324 to construct the vector database 342. For example, vector database generator 324 may be invoked, based on the encoder 318 generating embeddings corresponding to the document chunks of the electronic documents, to generate the vector database 342 using the embeddings. The vector database generator 324 may include instructions that, when executed by the set of processors 310, cause the set of processors 310 to construct the vector database 342 by indexing the embeddings using an approximate nearest neighbor (ANN) indexing structure, such as hierarchical navigable small world (HNSW) graphs, inverted file indices (IVF), or product quantization techniques, to enable efficient similarity search operations. The vector database 342 may store each embedding along with the corresponding document chunk of the electronic documents corresponding to the network security frameworks, thereby enabling retrieval of the portions of the electronic documents via retriever 320 when generating one or more recommendations or remedial actions via generator 322 of model 316.

In some embodiments, the collected data (or portions thereof) may be stored in the graph database 344 when the data processing system 306 generates the main-graph 346, in accordance with one or more implementations described herein. For example, the graph generator 328 may include instructions that, when executed by the set of processors 310, cause the set of processors 310 to generate the main-graph 346 comprising nodes corresponding to controls or requirements of the different network security frameworks (e.g., a first set of nodes) and nodes representing objects of the computing environments 304a-304c (e.g., a second set of nodes). For instance, in response to the data collector 314 collecting the electronic documents corresponding to network security frameworks and the computing object data from the computing objects 305a-305c, the graph generator 328 may generate the main-graph 346 using the collected data. The graph generator 328 may store the main-graph 346 in the graph database 344, thereby enabling the graph data retriever 330 to query the main-graph 346 during inference operations to identify relationships between network security framework controls or requirements and computing objects of the computing environments 304a-304c.

In some embodiments, the graph generator 328 may generate the first set of nodes corresponding to controls or requirements of the different network security frameworks. For example, the graph generator 328 may include instructions that, when executed by the set of processors 310, cause the set of processors 310 to apply natural language processing (NLP) techniques to extract control identifiers, requirement specifications, function categories, risk assessments, and family classifications from the electronic documents corresponding to the network security frameworks. The graph generator 328 may apply named entity recognition (NER) techniques to identify and extract specific entities such as control names, framework identifiers, compliance requirements, and security functions from the electronic documents. Each node of the first set of nodes may store an embedding (e.g., generated by the encoder 318 stored in the vector database 342) corresponding to a respective chunk of a network security framework document, a control or requirement represented by the node, a framework identifier indicating the associated network security framework (e.g., NIST CSF, SP 800-53, MITRE ATT&CK, CIS benchmarks, HIPAA, GDPR, SOC 2), a control identifier, a function category, a risk assessment, a family classification, or other network security framework information that the data collector 314 obtained.

The graph generator 328 may include instructions that, when executed by the set of processors 310, cause the set of processors 310 to generate the second set of nodes representing objects of the computing environments 304a-304c. For example, the graph generator 328 may apply NLP techniques to extract computing object information from the computing object data received by the data collector 314. In some embodiments, the graph generator 328 may generate the graph data structure using a network topology generated by the discovery agent manager 351. For example, the graph generator 328 may generate nodes representing each device represented in the network topology, where each node of the second set of nodes corresponds to a different device identified through the network discovery operations. Each node of the second set of nodes may store a vector embedding of the computing object generated by the encoder 318, a type classification indicating a category of the computing object (e.g., firewall, router, server, load balancer), an object identifier, state information indicating a current configuration or operational status of the computing object, a platform association indicating the computing platform on which the object operates, log information capturing activity or events associated with the computing object, network address information including private network address identifiers and public network address identifiers, network address translation mappings between original and rewritten addresses, or other computing object information that the data collector 314 obtained from the computing objects 305a-305c or that the discovery agent manager 351 obtains through network discovery operations.

The graph generator 328 may include instructions that, when executed by the set of processors 310, cause the set of processors 310 to generate edges representing relationships between the first set of nodes corresponding to the network security frameworks and the second set of nodes corresponding to the computing objects. For example, the graph generator 328 may apply relationship extraction techniques to identify associations between network security framework controls or requirements and computing objects within the computing environments 304a-304c. The graph generator 328 may generate an edge between a node of the first set of nodes and a node of the second set of nodes when the graph generator 328 determines that a control or requirement of a network security framework is applicable to a computing object. The graph generator 328 may determine applicability based on corresponding identifiers between the network security framework and the computing object, such as, for example, matching a platform identifier stored in a framework data node (e.g., indicating the framework applies to cloud platforms, on-premises systems, or specific operating systems) with a platform association stored in an object node representing a computing object operating on that platform. Additionally or alternatively, the graph generator 328 may determine applicability by determining the function category or control family of a network security framework control (e.g., access control, patch management, network segmentation) and determining a correspondence to the type classification of a computing object (e.g., firewall, router, server) that performs or is subject to that function.

The edges may store relationship information indicating the nature of the association between the connected nodes, such as an indication that a particular computing object is subject to a specific control or requirement of a network security framework. By generating the main-graph 346 with the first set of nodes, the second set of nodes, and the edges representing relationships therebetween, the graph generator 328 enables the data processing system 306 to preserve relationship information between syntactically dissimilar and syntactically similar elements of security frameworks and computing objects for subsequent subgraph generation and remedial action generation operations. Moreover, in some embodiments, the graph generator 328 may generate edges between nodes of the second set of nodes based on the network topology generated by the discovery agent manager 351. For example, the graph generator 328 may generate first edges between first pairs of the nodes represented based on the first one or more intermediate hops between the first device and the router, and second edges between second pairs of the nodes represented based on the second one or more intermediate hops between the second device and the router. The first edges may represent network connectivity relationships identified from the first trace-route type sequence, and the second edges may represent network connectivity relationships identified from the second trace-route type sequence. By generating edges based on the intermediate hops identified through the bi-directional network discovery operations, the graph generator 328 preserves the actual network topology structure within the graph data structure, enabling the graph neural network 332 to analyze network connectivity patterns when generating remedial actions.

As described above, each node of the first set of nodes stores an embedding corresponding to a chunk of a network security framework document indicating a control, requirement, or other related information of the network security framework. Leveraging such an architecture enables data processing system 306 to leverage similarity-search techniques when identifying applicable network security framework controls or requirements in response to a user request. For example, when the system is to generate a recommendation or remedial action, the system may perform a similarity search using the embedding of the user request against the embeddings stored within the vector database to identify nodes of the first set of nodes that identify applicable network security framework controls or requirements of information in the user request. By storing embeddings within the nodes of the graph data structure, the system overcomes the strict query requirements of conventional graph data structures that require exact matches to traverse and retrieve information. The system maintains the fuzziness advantages of similarity-search techniques while also preserving the relationship information between network security framework controls or requirements and computing objects 305 of computing environments 304 through the graph structure. In this way, the system may identify conceptually similar controls or requirements that are syntactically different, thereby generating improved remedial actions that account for cross-framework relationships and compliance gaps that would otherwise be missed by systems relying solely on syntactic similarity or strict graph queries.

In some embodiments, the system may update the vector database 342 or main-graph 346 based on the data collector 314 receiving or retrieving updated information. For example, when the data collector 314 receives updated electronic documents corresponding to network security frameworks or updated computing object data from the computing objects 305a-305c, the encoder 318 may generate new embeddings for storage in the vector database 342, and the graph generator 328 may update the main-graph 346 with new nodes or modified edges. Similarly, when the discovery agent manager 351 generates an updated network topology based on new network discovery operations, the graph generator 328 may update the main-graph 346 to include new nodes representing newly discovered devices, new edges representing newly identified network connections, or modified edges reflecting changes in network connectivity. The data processing system 306 may perform such updates periodically, in response to detected changes in source data, receiving push notifications from network security framework administrators, or other network discovery agent information. By maintaining current information in the vector database 342 and main-graph 346, the data processing system 306 can generate remedial actions based on the most recent network security framework guidance, computing environment configurations, and network topology.

The graph generator 328 may include instructions that, when executed by the set of processors 310, cause the set of processors 310 to generate one or more subgraphs 348 from the main-graph 346. For example, in response to data processing system 306 receiving a user input requesting information about network security frameworks as related to objects of a computing environment, the graph generator 328 may obtain one or more embeddings corresponding to the input generated by encoder 318 to identify corresponding embeddings stored in the vector database 342. Using the corresponding embeddings, the graph data retriever 330 may query the main-graph 346 (e.g., using the embeddings identified from the vector database 342) to identify a subset of the first set of nodes corresponding to applicable controls or requirements. The graph generator 328 may generate the subgraph 348 by extracting the identified subset of nodes along with a subset of the second set of nodes linked by edges with the identified first set of nodes. The subgraph 348 preserves the edges and relationship information between the extracted nodes of the main-graph 346, enabling the graph neural network 332 to process the subgraph 348 and identify patterns, infer connections between nodes that may not be explicitly preserved in the subgraph 348, and detect gaps such as expected-but-missing edges or nodes. In some embodiments, the graph generator 328 may enhance the subgraph 348 by generating additional edges (e.g., relationships) between the nodes in a manner that is the same or similar to that described above. By generating a targeted subgraph 348, the data processing system 306 reduces the computational complexity of subsequent processing operations when generating remedial actions or recommendations over the entire main-graph 346.

The model 316 may include the encoder 318, the retriever 320, and the generator 322. As described above, the encoder 318 may include instructions that, when executed by the set of processors 310, cause the set of processors 310 to generate embeddings from input data, including embeddings of electronic documents corresponding to network security frameworks, embeddings of computing object data, and embeddings of user inputs or queries.

In some embodiments, the model 316 may be the same or similar machine learning model as the first machine learning model 204 described above. For example, model 316 may be an LLM trained to generate remedial actions for cybersecurity vulnerabilities based on network security framework information, computing object information, or other information. In some embodiments, a user may interact with model 316 via client device 302.

For example, a user may transmit a natural language query via the client device 302, such as “What NIST SP 800-53 and CIS benchmark controls apply to the firewall and router configurations in my computing environment, and what remedial actions are needed to address any compliance gaps?” In response, the encoder 318 may generate embeddings of the query and transmit them to the retriever 320. The retriever 320 may perform a similarity search against the vector database 342 to identify embeddings of electronic document portions corresponding to applicable network security frameworks. For instance, the retriever 320 may identify embeddings corresponding to NIST SP 800-53 access control requirements and CIS benchmark firewall configuration controls that are semantically similar to the query.

The retriever 320 may include instructions that, when executed by the set of processors 310, cause the set of processors 310 to retrieve relevant information from the vector database 342 based on similarity search operations. For example, the retriever 320 may receive an embedding of a user input generated by the encoder 318 and perform a similarity search against the embeddings stored in the vector database 342 to identify portions of electronic documents corresponding to network security frameworks that are semantically similar to the user input. The retriever 320 may retrieve the identified portions of electronic documents (e.g., from the vector database 342 or from system data 350) and provide the retrieved portions to the generator 322 as context for generating a response or remedial action.

In some embodiments, the retriever 320 may be communicatively coupled to the graph data retriever 330 to enable the model 316 to generate recommendations based on graph data or graph outputs from the graph neural network 332. For example, the retriever 320 may transmit the embedding of the user input to the graph data retriever 330, and the graph data retriever 330 may query the main-graph 346 using the embedding to identify relevant nodes and relationships. The graph data retriever 330 may return graph data, such as identified nodes, edges, or subgraph information, to the retriever 320. The retriever 320 may combine the retrieved portions of electronic documents from the vector database 342 with the graph data received from the graph data retriever 330 and provide the combined information to the generator 322. By communicatively coupling the retriever 320 with the graph data retriever 330, the model 316 may generate recommendations or remedial actions that account for both the semantic content of network security framework documents and the relationship information preserved in the graph data structure.

The generator 322 may include instructions that, when executed by the set of processors 310, cause the set of processors 310 to generate outputs based on the context provided by the retriever 320. For example, the generator 322 may be or include portion of a large language model configured to generate natural language responses, recommendations, or remedial actions based on the retrieved portions of electronic documents corresponding to network security frameworks, graph data, graph neural network outputs, the user input, or other information. The generator 322 may process the context provided by the retriever 320 to generate a remedial action for addressing a gap in a control or requirement of an applicable security framework with respect to one or more objects of the computing environment. The generator 322 may generate the remedial action as a natural language description, a structured recommendation, or a set of actionable steps that can be implemented within the computing environment.

The graph data retriever 330 may include instructions that, when executed by the set of processors 310, cause the set of processors 310 to obtain data from the graph database 344. For example, the graph data retriever 330 may query the main-graph 346 stored in the graph database 344 using embeddings identified from the vector database 342 to identify a subset of nodes corresponding to applicable controls or requirements of network security frameworks. As another example, the graph data retriever 330 may query the subgraph 348 stored in the graph database 344 using the embeddings for other operations. The graph data retriever 330 may traverse the edges of the main-graph 346 to identify relationships between the identified nodes and other nodes representing computing objects of the computing environments 304a-304c. The graph data retriever 330 may retrieve the identified nodes, edges, and relationship information from the graph database 344 and provide the retrieved graph data to the graph generator 328 for subgraph generation or to the retriever 320 for inclusion in the context provided to the generator 322.

In some embodiments, the graph neural network 332 may be the same or similar machine learning model as the second machine learning model 204 described above. For example, the graph neural network 332 may be trained to generate outputs related to remedial actions for cybersecurity vulnerabilities. For example, the graph neural network 332 may generate remedial actions, recommendations, indications of relationships between network security framework information and computing object information, confidence scores of generated remedial actions, or other information.

The graph neural network 332 may include instructions that, when executed by the set of processors 310, cause the set of processors 310 to process subgraphs generated by the graph generator 328 to identify patterns, infer connections, and detect gaps in controls or requirements of network security frameworks with respect to objects of a computing environment based on a subgraph. For example, the graph neural network 332 may receive a subgraph 348 as input and process the nodes and edges of the subgraph 348 to generate graph outputs. The graph neural network 332 may analyze the edges between a first set of nodes (e.g., nodes corresponding to network security frameworks) and a second set of nodes (e.g., nodes corresponding to computing objects 305 of a computing environment 304) to identify compliance gaps, security vulnerabilities, or missing relationships between network security framework controls and computing objects. The graph outputs may include candidate remedial actions, confidence scores for the candidate remedial actions, indications of expected-but-missing edges or nodes within the subgraph, indications of unexpected nodes or edges, or inferred connections between conceptually similar controls that are syntactically different across different security frameworks.

The graph neural network 332 may be trained based on one or more historical subgraphs containing nodes generated based on the different network security frameworks, enabling the graph neural network 332 to recognize patterns indicative of compliance gaps or security vulnerabilities, including patterns that indicate missing relationships 358 between controls and computing objects. In some embodiments, the graph neural network 332 may generate a plurality of candidate remedial actions and confidence scores indicating the degree of certainty that each candidate remedial action will effectively address the identified gap. The graph neural network 332 may provide the graph outputs to the graph data retriever 330, which may provide the graph outputs to the retriever 320 for inclusion in the context provided to the generator 322. The generator 322 may execute a large language model using the plurality of candidate remedial actions and the confidence scores to select the remedial action from among the candidate remedial actions.

In some embodiments, the validator 334 may be the same or similar machine learning model as the third machine learning model 204 described above. For example, the validator 334 may be a validation large language model trained to validate remedial actions and evaluate completeness of remedial actions generated by the model 316 or derived from the graph neural network 332.

The validator 334 may include instructions that, when executed by the set of processors 310, cause the set of processors 310 to evaluate completeness of remedial actions relative to subgraphs and acceptance criteria. For example, the validator 334 may receive a remedial action, the subgraph 348 used to generate the remedial action, and acceptance criteria information specifying completeness requirements. The validator 334 may analyze the remedial action against the nodes and edges of the subgraph 348 and the graph outputs from the graph neural network 332 to determine whether the remedial action satisfies the acceptance criteria, such as coverage of applicable security framework controls, addressing of expected-but-missing edges or nodes, and inclusion of remedial actions for each computing object associated with relevant framework controls.

Responsive to determining that the remedial action is incomplete, the validator 334 may automatically trigger at least one additional iteration of the query of the graph data structure and the generation of the subgraph to obtain additional controls, requirements, or objects omitted from a prior iteration. In some embodiments, the validator 334 may generate a completeness score indicating a degree to which the remedial action addresses the nodes, edges, and relationships within the subgraph 348 relative to the acceptance criteria. The validator 334 may provide validation determinations to the generator 322, which may use the validation determinations to refine the remedial action or trigger additional processing iterations until the remedial action satisfies the acceptance criteria. By leveraging the validator 334 to remedial actions against the subgraph and acceptance criteria, the system (i) standardizes application of acceptance criteria to remedial actions, thereby forgoing subjective human-evaluator acceptances of remedial actions and (ii) comprehensively address compliance gaps across multiple network security frameworks, thereby reducing the likelihood of incomplete security assessments and improving the overall cybersecurity posture of the computing environment prior to a cybersecurity attack.

The model manager 336 may include instructions that, when executed by the set of processors 310, cause the set of processors 310 to manage the different machine learning models stored on, hosted on, or executed by the data processing system 306. For example, the model manager 336 may execute and train the model 316, the graph neural network 332, and the validator 334 to generate outputs based on data stored in the vector database 342, the graph database 344, and the system data 350. The model manager 336 may perform training operations using training data obtained from the system data 350, including network security framework information, computing object data, historical subgraphs, remedial actions, confidence scores, and validation determinations. The model manager 336 may update the configurations of the machine learning models based on error signals generated during training to improve the accuracy of generated outputs. The model manager 336 may also manage model versioning, model deployment, and model performance monitoring to ensure that the machine learning models operate effectively within the data processing system 306.

The action facilitator 338 may include instructions that, when executed by the set of processors 310, cause the set of processors 310 to implement remedial actions within the computing environments 304a-304c. For example, the action facilitator 338 may receive a remedial action (e.g., generated by the generator 322, graph neural network 332, the validator 334, or other component), and automatically implement the remedial action within the corresponding computing environment 304 or computing object 305 to reduce cybersecurity risk.

For example, the action facilitator 338 may apply natural language processing (NLP) techniques or other processing techniques to analyze the remedial action and determine how to implement the remedial action within the computing environment or computing object. For example, the action facilitator 338 may parse the remedial action to identify the type of remedial action (e.g., configuration change, security control adjustment, software update), the target computing object or computing environment to which the remedial action applies, and the specific parameters or settings to be modified. The action facilitator 338 may apply named entity recognition to extract computing object identifiers, control identifiers, configuration parameters, or other actionable elements from the remedial action. Additionally or alternatively, the action facilitator may query one or more of the graph data structures stored in graph database 344 to obtain sch information, thereby reducing computational resources expended on named entity recognition (e.g., as the graphs may already include such data). The action facilitator 338 may further apply text classification techniques to categorize the remedial action according to implementation requirements, such as determining whether the remedial action requires updating firewall rules, enabling multi-factor authentication, restricting network access permissions, applying software patches, or modifying other security configurations.

Subsequent to processing of remedial action, the action facilitator 338 may communicate with the applicable computing objects 305a-305c or computing environments 304a-304c via the communication interface 308 to obtain the applicable data required for implementation. For instance, the action facilitator 338 may retrieve a configuration profile, security policy settings, access control lists, software version information, or other data items from the target computing object or computing environment. The action facilitator 338 may modify the retrieved data according to the specifications identified in the remedial action, such as updating configuration parameters, adding or removing access permissions, or specifying software update instructions. The action facilitator 338 may then automatically transmit the modified data back to the appropriate computing object 305 or computing environment 304 to be implemented, thereby reducing cybersecurity risk within the computing environment prior to a cybersecurity attack. The action facilitator 338 may also generate implementation reports indicating the status of remedial action implementation, including successful implementations, failed implementations, and pending implementations requiring manual intervention.

The tracker 340 may include instructions that, when executed by the set of processors 310, cause the set of processors 310 to track the status of remedial actions, compliance gaps, and security posture changes within the computing environments 304a-304c. For example, the tracker 340 may maintain records of remedial actions generated by the generator 322, validation determinations generated by the validator 334, and implementation statuses generated by the action facilitator 338. The tracker 340 may monitor the computing environments 304a-304c to detect changes in compliance status, security configurations, or vulnerability states that may affect the applicability or effectiveness of previously generated remedial actions. The tracker 340 may generate alerts or notifications when new compliance gaps are detected, when remedial actions fail to be implemented, or when previously addressed vulnerabilities reappear within the computing environments 304a-304c. The tracker 340 may store tracking information in the system data 350 to enable historical analysis of security posture changes and remedial action effectiveness over time.

The discovery agent manager 351 may include instructions that, when executed by the set of processors 310, cause the set of processors 310 to manage and deploy discovery agent instances across the computing environments 304a-304c. For example, the discovery agent manager 351 may deploy a first instance of a network discovery agent to a first computing object 305 (e.g., a first device) and a second instance of the network discovery agent to a second computing object 305 (e.g., a second device) within a computing environment 304. The discovery agent manager 351 may deploy the discovery agent instances by transmitting executable code or installation packages to the respective computing objects 305 via the communication interface 308, or by activating pre-installed agent software on the computing objects 305. The discovery agent manager 351 may maintain a registry of deployed discovery agent instances, including identifiers of the computing objects on which the instances are executing, network addresses associated with each instance, operational states of the instances, and configuration parameters governing the behavior of each instance.

The discovery agent manager 351 may include instructions that, when executed by the set of processors 310, cause the set of processors 310 to execute the discovery agent instances to perform network probing operations. For example, the discovery agent manager 351 may execute the discovery agent instances in response to a trigger, such as receiving a user request via the client device 302, a scheduled discovery interval, receiving an event notification indicating a change in the computing environment 304, or receiving an instruction from another component of the data processing system 306. In response to the trigger, the discovery agent manager 351 may execute a first instance of the network discovery agent on the first device to transmit first one or more probes to a second instance of the network discovery agent on the second device, where the first one or more probes comprise a first trace-route type sequence and include a first network address of the first device. The discovery agent manager 351 may similarly execute the second instance of the network discovery agent on the second device to transmit second one or more probes to the first instance of the network discovery agent on the first device, where the second one or more probes comprise a second trace-route type sequence and include a second network address of the second device.

In some embodiments, the probes transmitted by the discovery agent instances may be or include Internet Control Message Protocol (ICMP) echo request packets, User Datagram Protocol (UDP) packets, Transmission Control Protocol (TCP) SYN packets, trace-route sequences, or other network packets configured to elicit responses from intermediate network devices. For example, the first trace-route type sequence and the second trace-route type sequence may each comprise transmitting a plurality of probes having successively varied time-to-live (TTL) values to elicit responses from intermediate hops along the network path between the first device and the second device. The discovery agent manager 351 may identify the intermediate hops based on addresses included in the responses, such as ICMP Time Exceeded messages returned by routers when the TTL value reaches zero.

In some embodiments, the discovery agent manager 351 may coordinate the discovery agent instances to exchange messages prior to initiating the probe sequences to determine whether the discovery agent instances can communicate with one another. For example, the discovery agent manager 351 may execute the first instance of the network discovery agent on the first device to transmit a first message to the second instance of the network discovery agent and execute the second instance of the network discovery agent on the second device to transmit a second message to the first instance of the network discovery agent. The messages may be or include connectivity verification packets, reachability test signals, acknowledgment messages, or other communications that confirm the discovery agent instances can communicate with one another across the network. In response to determining the second instance of the network discovery agent received the first message and the first instance of the network discovery agent received the second message, the discovery agent manager 351 may execute the first instance of the network discovery agent on the first device to transmit the first one or more probes to the second instance of the network discovery agent on the second device. By confirming that the two network discovery agents can communicate with one another prior to initiating the probe sequences, the discovery agent manager 351 ensures that the subsequent probe transmissions will successfully traverse the network path between the discovery agent instances, thereby enabling the system to obtain information concerning intermediate computing objects between the first device and the second device and generate an accurate network topology based on the identified intermediate hops.

The discovery agent manager 351 may include instructions that, when executed by the set of processors 310, cause the set of processors 310 to capture network packets via the discovery agent instances. For example, the discovery agent manager 351 may instruct a discovery agent instance to intercept data packets transmitted from and received by the computing object on which the discovery agent instance is installed. The discovery agent instances may capture outgoing data packets originating from the respective computing objects and incoming data packets destined for the respective computing objects to obtain network topology information, including source addresses, destination addresses, routing paths, and connection patterns. The discovery agent manager 351 may receive the captured network packets from the deployed discovery agent instances via the communication interface 308, where the discovery agent instances transmit the captured packet data to the discovery agent manager 351. The discovery agent manager 351 may analyze the captured packets to identify network addresses, communication endpoints, and network links within the computing environment 304, thereby enabling the generation of an accurate network topology based on observed traffic patterns.

The discovery agent manager 351 may include instructions that, when executed by the set of processors 310, cause the set of processors 310 to retrieve network discovery data from the discovery agent instances. For example, the discovery agent manager 351 may leverage the captured data packets to retrieve header information from probes transmitted by the first discovery agent instance and header information from the same probes as received at the second discovery agent instance. The discovery agent manager 351 may determine a network address translation at a router between the first device and the second device based at least on a change in the first network address received in a header of a first probe at the second device or the second network address received in a header of a second probe at the first device. The discovery agent manager 351 may determine the network address translation by comparing at least one header field of the first probe as transmitted by the first device to a corresponding header field of the first probe as received at the second device, the header field comprising at least one of a source address or a source port. The discovery agent manager 351 may determine the network address translation in response to determining the comparison indicating the compared header fields do not match.

For example, the discovery agent instance 402a on the first device may transmit a probe packet with a source address of 192.168.1.10 and a source port of 54321, and the discovery agent manager 351 may record these transmitted header values. When the discovery agent instance 402b on the second device receives the same probe packet, the discovery agent manager 351 may retrieve the received header information and determine that the source address has been rewritten to 203.0.113.50 and the source port has been changed to 12345. By comparing the transmitted source address of 192.168.1.10 against the received source address of 203.0.113.50 and determining that these values do not match, the discovery agent manager 351 may determine that network address translation has occurred at an intermediate router along the network path. The discovery agent manager 351 may further identify the specific router performing the translation by correlating the point at which the address change occurs with the intermediate hops identified from the trace-route type sequences. This bi-directional comparison approach enables detection of network address translation that would otherwise be invisible to single-perspective network scanning tools.

The discovery agent manager 351 may include instructions that, when executed by the set of processors 310, cause the set of processors 310 to identify intermediate hops and generate a network topology. For example, the discovery agent manager 351 may identify, from the first trace-route type sequence, first one or more intermediate hops between the first device and the router, and, from the second trace-route type sequence, second one or more intermediate hops between the second device and the router. The discovery agent manager 351 may identify the intermediate hops by extracting or parsing trace-route sequence information received from the discovery agent instances. For example, when a first discovery agent instance transmits probes with successively varied time-to-live values toward a second discovery agent instance, each intermediate computing object along the network path decrements the time-to-live value and, upon the value reaching zero, returns an ICMP Time Exceeded message containing the address of that intermediate computing object. The discovery agent manager 351 may parse these response messages to extract the addresses of the computing objects that the probes communicated with enroute to the destination discovery agent instance. For instance, the discovery agent manager 351 may extract from the first trace-route type sequence a first address corresponding to a first intermediate hop, a second address corresponding to a second intermediate hop, and a third address corresponding to a third intermediate hop, thereby identifying each intermediate hop between the first discovery agent instance and the second discovery agent instance. The discovery agent manager 351 may similarly parse the second trace-route type sequence transmitted from the second discovery agent instance toward the first discovery agent instance to extract addresses of intermediate computing objects traversed in the reverse direction. The discovery agent manager 351 may generate a network topology for the computing environment based at least on the first one or more intermediate hops, the router, and the second one or more intermediate hops.

The discovery agent manager 351 may further retrieve a routing table from the router identified from the first one or more probes or the second one or more probes. The routing table may include entries specifying destination network prefixes, next-hop addresses, interface identifiers, routing metrics, and administrative distances that indicate how the router forwards packets to various network destinations. The discovery agent manager 351 may analyze the routing table entries to identify additional network segments, subnets, or connected interfaces that may not have been directly traversed by the probe sequences but are reachable through the router. For example, the routing table may indicate that the router has interfaces connected to multiple network segments, and the discovery agent manager 351 may use this information to identify additional devices or network paths that exist within the computing environment but were not encountered during the trace-route type sequences. The discovery agent manager 351 may correlate the next-hop addresses specified in the routing table entries with the intermediate hop addresses identified from the probe sequences to verify network connectivity and identify potential alternate routing paths. Additionally, the discovery agent manager 351 may use routing metric information from the routing table to determine preferred paths and identify load-balanced or redundant network configurations. The discovery agent manager 351 may generate the network topology based at least on the routing table in combination with the first one or more intermediate hops and the second one or more intermediate hops, thereby producing a comprehensive representation of the network structure that includes both actively probed paths and configured routing relationships.

When conflicts arise between the network topology generated from the intermediate hops and the routing table, the discovery agent manager 351 may address the conflict by providing priority to the first one or more intermediate hops and the second one or more intermediate hops. A conflict may occur, for example, when the routing table indicates a direct path between two devices but the probe sequence reveals an additional intermediate hop, or when the routing table specifies a particular next-hop address that differs from the intermediate device address observed in the trace-route responses. Such conflicts arise because routing tables represent configured routing policies that may not accurately reflect current traffic flow patterns due to load balancing, policy-based routing, or network changes that have not been updated in the routing table entries. Providing priority to the probe-derived intermediate hops may be that when the discovery agent manager 351 constructs the network topology, the system uses the hop sequence identified from the actual probe transmissions rather than the path indicated by the routing table entries, as the probe-derived data reflects observed network behavior during the discovery operation. By prioritizing the intermediate hops identified from the trace-route type sequences, the discovery agent manager 351 generates a network topology that accurately represents the actual communication paths traversed by network traffic within the computing environment.

The discovery agent manager 351 may include instructions that, when executed by the set of processors 310, cause the set of processors 310 to map network addresses and provide the generated network topology to the graph generator 328. For example, the discovery agent manager 351 may map a changed network address observed in a header of a received probe to a corresponding original network address transmitted by the first instance or the second instance, and represent the mapped addresses as a single device within the generated network topology. This mapping approach prevents the network topology from incorrectly representing a single device as multiple distinct devices due to address translation effects. The discovery agent manager 351 may provide the generated network topology to the graph generator 328 for incorporation into the graph data structures stored in the graph database 344. The graph generator 328 may update the main-graph 346 or generate a subgraph 348 based on the network topology, including nodes representing devices (e.g., computing objects) identified through the network discovery operations and edges representing network connections between the devices. By integrating network discovery data with the graph data structures, the data processing system 306 may generate remedial actions that account for the actual network topology of the computing environment 304, including devices and connections that may not be apparent from static configuration data alone, thereby improving the accuracy and completeness of security assessments.

FIG. 3B illustrates an example graph data structure, in accordance with an implementation. For example, FIG. 3B illustrates an example of the main-graph 346 storing nodes representing network security framework information and computing objects of computing environments, in accordance with an implementation. As illustrated, the main-graph 346 can include one or more framework nodes 352a-352c (individually, framework node 352 and together, framework nodes 352) that represent controls or requirements of different network security frameworks. The main-graph 346 can also include one or more object nodes 354a-354d (individually, object node 354 and together, object nodes 354) that represent objects of computing environments. The framework nodes 352 and object nodes 354 can be connected by edges (e.g., relationships 356a-356f) that each represent associations between the respective nodes. The framework nodes 352 can each include one or more node field-value pairs for different types of characteristics or attributes of the network security framework controls or requirements represented by the framework nodes 352. The framework nodes 352 can include one or more attributes such as, for example, a vector embedding corresponding to a chunk of a network security framework document, a framework identifier indicating the associated network security framework (e.g., NIST CSF, SP 800-53, MITRE ATT&CK, CIS benchmarks, HIPAA, GDPR, SOC 2), a control identifier (e.g., AC-1, AC-2, SC-7), a function category (e.g., Identify, Protect, Detect, Respond, Recover), a risk assessment indicating severity or priority levels, a family classification (e.g., Access Control, System and Communications Protection, Incident Response), a requirement specification describing the control objective, implementation guidance, assessment procedures, related controls, or other information extracted from network security framework documents.

The object nodes 354 can each include one or more node field-value pairs for different types of characteristics or attributes of the computing objects represented by the object nodes 354. The object nodes 354 can include one or more attributes such as, for example, a vector embedding of the computing object (or alternatively, a vector embedding of the respective object node 354 itself), a type classification indicating a category of the computing object (e.g., firewall, router, server, load balancer, intrusion detection system, endpoint device, virtual machine, database), an object identifier (e.g., a particular type, manufacturer, model, or other granular information of the computing object), state information indicating a current configuration or operational status of the computing object, a platform association indicating the computing platform on which the object operates (e.g., cloud platform, on-premises system, specific operating system), log information capturing activity or events associated with the computing object, network segment information, software version information, patch status, security policy configurations, network address information including private network address identifiers and public network address identifiers obtained from the discovery agent manager 351, network address translation mappings between original and rewritten addresses identified through bi-directional probing operations, intermediate hop data indicating the position of the computing object within network paths identified from trace-route type sequences, routing table entries retrieved from routers identified during network discovery operations, device connectivity relationships indicating which computing objects are connected to which other computing objects based on the network topology generated by the discovery agent manager 351, or other computing object information.

The edges (e.g., relationships 356a-356f) of the main-graph 346 can be or include data structures (e.g., edge data structures). For example, the edge data structures can each include one or more edge field-value pairs for different types of characteristics or attributes of the relationships represented by the edges. The edges can include one or more attributes such as, for example, a relationship type indicating the nature of the association between connected nodes (e.g., “applies to,” “is subject to,” “implements,” “mitigates”), an applicability indicator specifying whether a control or requirement applies to a particular computing object, a compliance status indicating whether the computing object satisfies the associated control or requirement, a timestamp indicating when the relationship was established or last updated, a confidence score indicating the strength or certainty of the relationship, cross-framework mapping information indicating conceptually similar controls across different security frameworks, network connectivity information derived from the network topology generated by the discovery agent manager 351 indicating network paths between computing objects, hop sequence information indicating the intermediate hops between connected computing objects identified from trace-route type sequences, network address translation boundary information indicating whether the relationship spans a NAT boundary identified through comparison of transmitted and received probe headers, or other relationship information. The edge data structures can each include identifiers of the nodes that the edges are connecting, in some cases forming the edge in a structured manner that enables traversal between framework nodes 352 and object nodes 354. In some embodiments, the graph generator 328 may generate edges between object nodes 354 based on the first one or more intermediate hops between a first device and a router and the second one or more intermediate hops between a second device and the router, as identified by the discovery agent manager 351 through coordinated network discovery operations.

In some embodiments, the main-graph 346 may be a non-computing-environment-specific and non-network-security-framework-specific graph data structure that includes all available information that the data collector 314 has collected and continues to collect over time, including network topology information received or generated by the discovery agent manager 351. For example, the main-graph 346 may aggregate network security framework information from multiple different frameworks (e.g., NIST CSF, SP 800-53, MITRE ATT&CK, CIS benchmarks, HIPAA, GDPR, SOC 2), computing object data from all computing environments 304a-304c and computing objects 305a-305c, network topology data including intermediate hops identified from trace-route type sequences, network address translation mappings detected through bi-directional probing, routing table entries retrieved from discovered routers, and relationship information between the framework nodes 352 and object nodes 354.

As the data collector 314 receives updated electronic documents corresponding to network security frameworks or updated computing object data, or as the discovery agent manager 351 generates updated network topologies based on new network discovery operations, the graph generator 328 may update the main-graph 346 with new nodes representing newly discovered devices, modified node attributes reflecting updated network address information or device connectivity relationships, or new edges representing newly identified relationships including network connections identified from the intermediate hops. By maintaining a comprehensive main-graph 346 that encompasses collected information including network discovery data, the data processing system 306 can generate targeted subgraphs that are specific to particular user queries, computing environments, or network security frameworks without requiring separate graph construction for each query. This approach reduces computational overhead during inference operations, as the system can extract relevant portions of the pre-constructed main-graph 346 rather than building graph structures from raw data for each request. Additionally, the comprehensive nature of the main-graph 346, enhanced with accurate network topology information that accounts for network address translation effects, enables the identification of cross-framework relationships and compliance gaps that span multiple network security frameworks and accurately reflect the true structure of devices on both sides of NAT boundaries, thereby providing more complete security assessments than systems that analyze individual frameworks in isolation or rely on incomplete network topology information.

The data processing system 306 can generate the graph data structure 346 for a particular computing environment. For example, the data processing system 306 can receive or ingest data or electronic records describing the computing environment of a computing system. The data processing system 306 can do so automatically responsive to being plugged into the computing system or responsive to receiving a request from the computing system. The data processing system can receive or ingest the data or electronic records in the request or after receiving the data or electronic records in one or more messages. In some cases, the data processing system can retrieve (e.g., automatically retrieve) the data or records from one or more data repositories in the computing system, such as in response to being connected with the computing system (e.g., with a computing device of the computing system).

The data processing system 306 can process the ingested data or electronic records to generate the main graph 346. For example, the data processing system 306 can generate the nodes 352 and 354 and the edges describing the relationships between the nodes 352 and 354 using the data or electronic records, as described herein. Each of the nodes can include a vector or embedding representing or describing the data from which the nodes were generated. The data processing system 306 can generate a vector database containing the data or electronic records. The data processing system 306 can generate the vector database to include the same embeddings as the main graph 346 as associations with the same corresponding data or electronic records.

FIG. 3C illustrates an example subgraph data structure of the example graph data structure of FIG. 3B, in accordance with an implementation. For example, FIG. 3B illustrates an example of the subgraph 348 representing a targeted subset of the main-graph 346 that is generated based on a user query or input. As illustrated in FIG. 3C, the subgraph 348 can include a subset of the framework nodes 352 and a subset of the object nodes 354 from the main-graph 346, along with the edges connecting the included nodes. For example, the subgraph 348 can include framework nodes 352a and 352b representing controls or requirements of network security frameworks applicable to a particular computing environment, and object nodes 354a and 354b representing objects of the computing environment that are relevant to the user query. The object nodes 354a and 354b within the subgraph 348 may include network discovery information obtained by the discovery agent manager 351, such as network address information, network address translation mappings, intermediate hop positions within the network topology, and device connectivity relationships identified through the coordinated bi-directional probing operations.

The graph generator 328 may generate the subgraph 348 from the main-graph 346 based on embeddings identified from the vector database 342 and network topology information generated by the discovery agent manager 351. For example, in response to receiving an input requesting information about network security frameworks as related to objects of a computing environment, the encoder 318 may generate an embedding of the input. The retriever 320 may perform a similarity search against the vector database 342 using the embedding of the input to identify one or more embeddings of portions of electronic documents corresponding to network security frameworks applicable to the computing environment. The graph data retriever 330 may query the main-graph 346 using the identified embeddings to identify a subset of the framework nodes 352 that correspond to controls or requirements of the network security frameworks applicable to the computing environment. The graph generator 328 may then generate the subgraph 348 from the identified subset of framework nodes 352 and a subset of object nodes 354 linked by edges with the identified framework nodes 352. In some embodiments, the graph generator 328 may generate the subgraph 348 using the network topology generated by the discovery agent manager 351, including generating edges between object nodes 354 based on the first one or more intermediate hops between a first device and a router and the second one or more intermediate hops between a second device and the router, thereby preserving the actual network connectivity structure within the subgraph 348.

The subgraph 348 preserves the edges and relationship information between the extracted nodes, including network connectivity relationships derived from the network topology generated by the discovery agent manager 351. As illustrated, the subgraph 348 includes relationships 356a, 356b, and 356c connecting the framework nodes 352a and 352b with the object nodes 354a and 354b. The edges within the subgraph 348 may include network topology information such as hop sequence data indicating the intermediate hops between connected computing objects, network address translation boundary information indicating whether the relationship spans a NAT boundary, and device connectivity relationships identified through the bi-directional probing operations performed by the discovery agent instances 402a and 402b.

The subgraph 348 may also include a missing relationship 358, depicted as a dashed line, indicating an expected-but-missing edge between nodes that the graph neural network 332 may identify during processing. For example, the missing relationship 358 may indicate a gap in a control or requirement of an applicable security framework with respect to a computing object, where the graph neural network 332 infers that a relationship should exist based on patterns learned from historical subgraphs but the relationship is not explicitly present in the subgraph 348. The missing relationship 358 may also indicate an expected network connectivity relationship between computing objects that should exist based on the network topology generated by the discovery agent manager 351 but is not reflected in the current compliance mapping. In response to identifying the expected-but-missing edge, the graph generator 328 may update the subgraph 348 to include the edge.

Similarly, the graph neural network 332 may identify an expected-but-missing node within the subgraph 348, indicating that a framework node 352 or object node 354 should be present based on patterns learned from historical subgraphs but is not explicitly included in the subgraph 348. For example, the graph neural network 332 may identify an expected-but-missing object node 354 corresponding to a computing object that was discovered by the discovery agent manager 351 through the network discovery operations but was not initially included in the subgraph 348, such as an intermediate hop device identified from the trace-route type sequences or a device hidden behind a NAT boundary that was revealed through comparison of transmitted and received probe headers. In response to identifying the expected-but-missing node, the graph generator 328 may update the subgraph 348 to include the node along with any associated edges connecting the node to existing nodes within the subgraph 348, including edges representing network connectivity relationships derived from the network topology.

Additionally, the graph neural network 332 may identify an unexpected node or edge within the subgraph 348, indicating that a node or relationship is present that should not exist based on patterns learned from historical subgraphs. For example, the graph neural network 332 may identify an unexpected object node 354 that represents a device appearing as multiple distinct devices due to network address translation effects, where the discovery agent manager 351 has determined through comparison of transmitted and received probe headers that the multiple addresses correspond to a single device and should be represented as a single node within the subgraph 348. In response to identifying an unexpected node or edge, the graph generator 328 may update the subgraph 348 to remove the unexpected node or edge, consolidate multiple nodes representing the same device based on network address translation mappings, or flag the unexpected node or edge for further analysis.

By updating the subgraph 348 based on expected-but-missing edges, expected-but-missing nodes, and unexpected nodes or edges identified by the graph neural network 332, and by incorporating accurate network topology information generated by the discovery agent manager 351 including network address translation mappings, intermediate hop data, and device connectivity relationships, the data processing system 306 can generate more accurate and complete subgraphs that reflect the true relationships between network security framework controls or requirements and computing objects, thereby improving the quality of remedial actions generated based on the subgraph 348 and reducing the likelihood of incomplete security assessments. The integration of network discovery data enables the subgraph 348 to accurately represent devices hidden behind NAT boundaries, account for asymmetric routing paths, and include intermediate network devices that may not respond to standard probes but were identified through the coordinated bi-directional probing operations. Furthermore, by generating the subgraph 348 as a targeted extraction from the main-graph 346 that incorporates the network topology, the data processing system 306 reduces the computational complexity of subsequent processing operations (e.g., graph neural network processing, etc.) while preserving the relationship information necessary for generating remedial actions that address the actual network structure of the computing environment.

### D. Systems and Methods for Enhanced Discovery of Network Devices and Facilitating Remedial Actions to Cybersecurity Vulnerabilities

Existing network discovery tools, such as conventional network scanning utilities, packet analysis tools, and traditional traceroute utilities, face several technical limitations when attempting to accurately map network topologies in environments implementing network address translation (NAT). These tools operate from a single-node perspective, relying on active probing or passive packet capture from a single device, and fundamentally lack the ability to compare probe headers across multiple devices to detect address translation performed by intermediate routers. For example, when a router performs NAT, it rewrites packet header fields including source addresses and ports, effectively hiding the true internal addressing scheme from any single scanning device. Existing systems, such as conventional network scanners, cannot detect this translation because they only observe packets from one vantage point and have no mechanism to compare what was transmitted by a source device against what was received at a destination device. As a result, these tools produce incomplete or inaccurate topology maps that fail to identify devices hidden behind NAT boundaries, miss asymmetric routing paths where traffic flows differently in each direction, and cannot distinguish between a single device with multiple translated addresses versus multiple distinct devices.

Furthermore, existing network discovery systems lack automated mechanisms to integrate and correlate data outputs from active probing with passive traffic capture, resulting in fragmented topology representations that consume substantial computational resources while remaining incomplete. The architectural separation between active probing systems and passive capture systems prevents automated reconciliation of conflicting representations between traceroute-derived hop lists and routing table data, as these systems store data in incompatible formats and lack shared data models for representing network topology information. Such fragmented architectures fail to automatically detect intermediate devices that do not respond to standard probes, such as transparent firewalls, intrusion prevention systems, or packet inspection appliances that sit inline but do not decrement time-to-live values or generate ICMP responses, because existing systems lack the bi-directional comparison mechanisms necessary to infer the presence of such devices from discrepancies between transmitted and received packet headers. Even when topology information is obtained through these existing approaches, the systems do not include data structures or processing pipelines that automatically map discovered devices or identified vulnerabilities to specific controls or requirements of network security frameworks such as NIST CSF, SP 800-53, MITRE ATT&CK, CIS benchmarks, HIPAA, or GDPR. This absence of integrated compliance mapping functionality prevents systematic correlation of discovered network structures and associated risks to specific regulatory requirements, leaving gaps in security assessments and failing to generate actionable, framework-specific remediation plans that address the cybersecurity posture of the computing environment prior to a cybersecurity attack.

To overcome these technical deficiencies, the methods and systems described herein enhance discovery of network devices within computing environments by coordinating instances of network discovery agents to detect network address translation, generate accurate network topologies, and automatically map discovered devices to security framework controls for generating remedial actions. For example, the system addresses the technical limitations of existing single-node network scanning tools by executing a first instance of a network discovery agent on a first device to transmit (e.g., cause the first instance of the network discovery agent to transmit) first one or more probes comprising a first trace-route type sequence to a second instance of the network discovery agent on a second device, and executing the second instance to transmit (e.g., cause the second instance of the network discovery agent to transmit) second one or more probes comprising a second trace-route type sequence back to the first instance. By comparing header fields of probes as transmitted by one discovery agent instance against the corresponding header fields as received at the other discovery agent instance, the system determines whether network address translation has occurred at an intermediate router based on detecting changes in source addresses or source ports. This coordinated, bi-directional probing approach overcomes the inability of existing tools such as conventional network scanners and traditional traceroute utilities to detect NAT, as these tools operate from a single vantage point and fundamentally lack mechanisms to compare transmitted versus received packet headers across multiple devices.

The bi-directional probing approach further enhances detection of network address translation in scenarios where disparate communication paths exist between computing devices within a computing environment. For example, in network configurations where outbound traffic flows from a different route than inbound traffic due to asymmetric routing policies, multiple gateway deployments, or other reasons, a single-perspective scanning tool may only observe a single direction of traffic flow and fail to detect network address translation that may occur on another traffic flow path. By leveraging bi-directional probes stemming from different discovery agent instances on different computing devices, the system captures header information from multiple existent paths, thereby facilitating NAT detection that may only occur on one of the existent paths.

Furthermore, the bi-directional coordination between the discovery agent instances also improves router location within the computing environment to more accurately capture the network topology on both sides of a NAT boundary. For example, when private networks are implemented behind a NAT performing router, computing devices behind the NAT performing router are not able to be detected by external scanning tools because the router translates the private addresses into public addresses before data packets leave the private network. As such, by executing an instance of the network discovery agent on a device within the private network and an instance of the network discovery agent on a device within the public network, the system may obtain visibility into the private addressing scheme and the intermediate hops between the network discovery agent instances that would otherwise be undetectable from external scanning tools alone. As the network discovery agent instances compare returned addresses from the probes, the system identifies the location of the router within the computing environment-thereby facilitating improved network topology generation.

The system further improves accuracy and reduces computational resource requirements by generating a unified network topology based on the first one or more intermediate hops identified from the first trace-route type sequence, the router performing network address translation, and the second one or more intermediate hops identified from the second trace-route type sequence. For example, the trace-route type sequences each comprise transmitting a plurality of probes having successively varied time-to-live values to elicit responses from intermediate hops, and the system identifies the intermediate hops based on addresses included in the responses. By mapping changed network addresses observed in headers of received probes to corresponding original network addresses transmitted by the discovery agent instances and representing the mapped addresses as a single device within the generated network topology, the system produces an accurate representation of the network structure that accounts for address translation effects, in some cases being able to identify the particular network location of the router or device performing the translation. This approach reduces the computational overhead required by existing systems that lack integrated data structures for combining active probing results with passive traffic capture data, while simultaneously improving topology accuracy by automatically reconciling conflicting representations between traceroute-derived hop lists and routing table data through defined priority rules that existing systems cannot implement due to their fragmented architectures.

The system then transforms the generated network topology into a graph data structure comprising a first set of nodes corresponding to controls or requirements of one or more network security frameworks and a second set of nodes corresponding to different devices of the network topology, with edges representing relationships between compliance controls and discovered devices. The system may leverage the graph data structure to generate a remedial action to reduce cybersecurity risk of the computing environment. For example, by generating the graph data structure and using it to generate, and automatically implement remedial actions, the system facilitates proactive addressing of cybersecurity vulnerabilities to reduce cybersecurity risk of the computing environment.

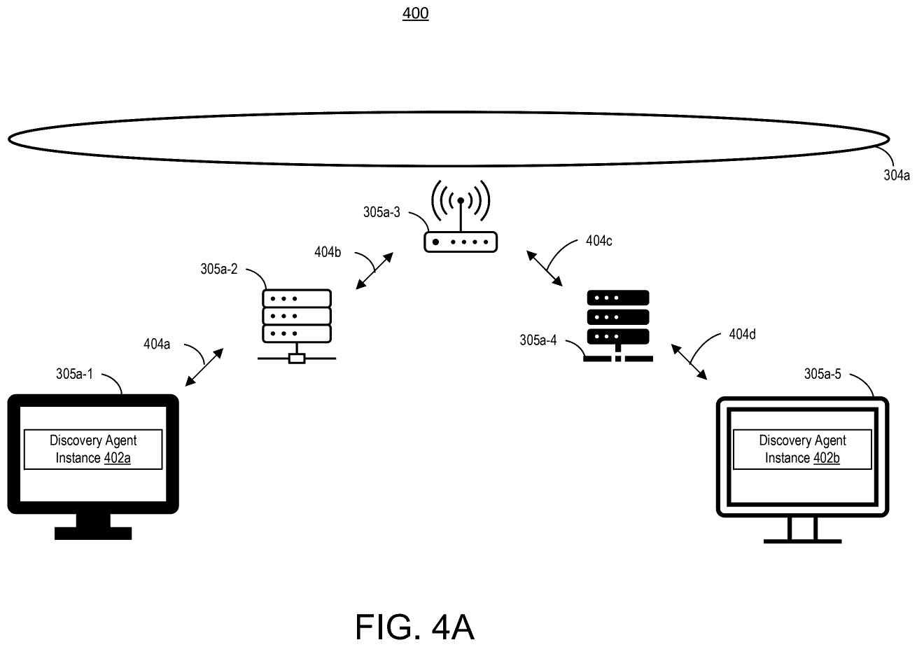

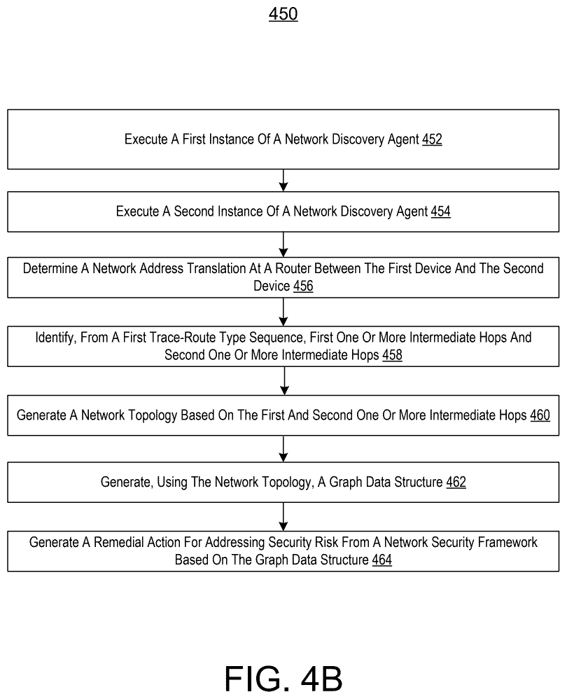

FIG. 4A is an illustration of an example subsystem to example subsystem to enhance discovery of network devices within computing environments, in accordance with an implementation. For example, subsystem 400 may include one or more components of FIG. 3A to enhance discovery of network devices within computing environments. Furthermore, FIG. 4A shows a computing environment 304 that includes computing objects 305a-1-305a-5, discovery agent instances 402a-402b, hops 404a-404d, or other components. It should be noted that, FIG. 4A indicating subsystem 400 illustrates an example of how the system and methods described herein may be performed, and that subsystem 400 may include one or more additional computing objects 305, discovery agent instances 402, hops 404, or other components.

In some embodiments, discovery agent manager 351 may deploy discovery agent instances 402 to one or more computing objects 305 that are part of a computing environment 304. As described above with reference to FIG. 3A, the discovery agent manager 351 may deploy the discovery agent instances by transmitting executable code or installation packages to the respective computing objects 305 via the communication interface 308, or by activating pre-installed agent software on the computing objects 305. The discovery agent manager 351 may maintain a registry of deployed discovery agent instances, including identifiers of the computing objects on which the instances are executing, network addresses associated with each instance, operational states of the instances, and configuration parameters governing the behavior of each instance. The discovery agent manager 351 may execute, or cause execution of, the discovery agent instances in response to a trigger, such as receiving a user request via the client device 302, a scheduled discovery interval, receiving an event notification indicating a change in the computing environment 304, or receiving an instruction from another component of the data processing system 306.

Referring to FIG. 4A, the network discovery subsystem 400 includes a discovery agent instance 402a deployed on computing object 305a-1 (e.g., a first device) and a discovery agent instance 402b deployed on computing object 305a-5 (e.g., a second device) within the computing environment 304a. A network discovery agent is a software component that executes on a computing device to probe and analyze network connectivity, identify other devices on the network, and collect information about network paths and configurations. In response to the trigger, the discovery agent manager 351 may execute the first instance of the network discovery agent (e.g., discovery agent instance 402a) on the first device (e.g., computing object 305a-1) to transmit first one or more probes to the second instance of the network discovery agent (e.g., discovery agent instance 402b) on the second device (e.g., computing object 305a-5).

For example, the first one or more probes may include a first trace-route type sequence and include a first network address of the first device. A trace-route type sequence is a series of network packets transmitted with incrementally increasing time-to-live (TTL) values, where each packet is designed to expire at successive points along the network path, causing intermediate devices to send response messages that reveal their network addresses. The discovery agent manager 351 may also execute the second instance of the network discovery agent on the second device to transmit second one or more probes to the first instance of the network discovery agent on the first device, where the second one or more probes include a second trace-route type sequence and include a second network address of the second device.

In some embodiments, prior to initiating the probe sequences, the discovery agent manager 351 may execute the first instance of the network discovery agent on the first device to transmit a first message to the second instance of the network discovery agent and execute the second instance of the network discovery agent on the second device to transmit a second message to the first instance of the network discovery agent. For example, the discovery agent instance 402a on computing object 305a-1 may transmit a connectivity verification message to the discovery agent instance 402b on computing object 305a-5, and the discovery agent instance 402b may transmit a corresponding acknowledgment message back to the discovery agent instance 402a.

The discovery agent manager 351 may execute the first instance of the network discovery agent on the first device to transmit the first one or more probes to the second instance of the network discovery agent on the second device in response to determining the second instance of the network discovery agent received the first message and the first instance of the network discovery agent received the second message. The discovery agent manager 351 may determine that the second instance of the network discovery agent received the first message by receiving an acknowledgment response from the discovery agent instance 402b indicating successful receipt of the first message, or by receiving a notification from the discovery agent instance 402b transmitted via the communication interface 308 confirming that the first message was received and processed. Similarly, the discovery agent manager 351 may determine that the first instance of the network discovery agent received the second message by receiving an acknowledgment response from the discovery agent instance 402a indicating successful receipt of the second message, or by querying the discovery agent instance 402a to retrieve a status indicator confirming receipt of the second message. By confirming bidirectional communication capability between the discovery agent instances 402a and 402b prior to initiating the probe sequences, the discovery agent manager 351 ensures that subsequent probe transmissions will successfully traverse the network path, thereby enabling accurate identification of intermediate computing objects between the first device and the second device.

The first trace-route type sequence and the second trace-route type sequence may each include transmitting a plurality of probes having successively varied time-to-live values to elicit responses from intermediate hops. As noted above, the time-to-live (TTL) value is a field in a network packet header that specifies the maximum number of network devices the packet can traverse before being discarded, and each device that forwards the packet decrements this value by one. An intermediate hop may refer to a network device that a packet passes through on its journey from a source device to a destination device, including routers, switches, servers, firewalls, proxies, load balancers, intrusion prevention systems, packet inspection appliances, transparent network bridges, virtualized network functions, or other network elements that may sit inline along the network path.

For example, the discovery agent instance 402a may transmit a first probe onto the network with a time-to-live value of one, which causes computing object 305a-2 to decrement the time-to-live value to zero when the probe hops (e.g., hop 404a) to the computing object 305a-2, and causes the computing object 305a-2 to return an ICMP Time Exceeded message containing the address of computing object 305a-2. An ICMP Time Exceeded message is a response packet sent by a network device when it receives a packet whose TTL has reached zero, and this message includes the network address of the device that generated the response. The discovery agent instance 402a may then transmit a second probe with a time-to-live value of two, which causes computing object 305a-2 to decrement the time-to-live value to one when the probe hops (e.g., hop 404a) to the computing object 305a-2, and causes computing object 305a-3 to decrement the time-to-live value to zero when the probe hops (e.g., hop 404b) to the computing object 305a-3, causing the computing object 305a-3 to return an ICMP Time Exceeded message containing the address of computing object 305a-3. This process continues with successively incremented time-to-live values until the probes reach the discovery agent instance 402b on computing object 305a-5. The discovery agent manager 351 may identify the intermediate hops based on addresses included in the responses. As illustrated in FIG. 4A, the intermediate hops 404a, 404b, 404c, and 404d represent network connections between computing objects 305a-1, 305a-2, 305a-3, 305a-4, and 305a-5 along the network path.

In some embodiments, the discovery agent manager 351 may determine a network address translation at a router between the first device and the second device based at least on a change in the first network address received in a header of a first probe at the second device or the second network address received in a header of a second probe at the first device. As described above, Network Address Translation (NAT) is a technique performed by routers or similar network devices that modifies the source or destination address information in packet headers as packets pass through, typically to allow devices with private internal addresses to communicate with external networks using a different public address. The discovery agent manager 351 may determine the network address translation by comparing at least one header field of the first probe as transmitted by the first device to a corresponding header field of the first probe as received at the second device, the header field including at least one of a source address or a source port. A source address is the network address identifying the device that originated a packet, while a source port is a numerical identifier used to distinguish different communication sessions from the same device.

For example, the discovery agent instance 402a on computing object 305a-1 may transmit a probe packet with a source address of 192.168.1.10 and a source port of 54321, and the discovery agent manager 351 may record these transmitted header values. When the discovery agent instance 402b on computing object 305a-5 receives the same probe packet, the discovery agent manager 351 may retrieve the received header information and determine that the source address has been rewritten to 203.0.113.50 and the source port has been changed to 12345. The discovery agent manager 351 may determine the network address translation in response to determining the comparison indicating the compared header fields do not match. By comparing the transmitted source address against the received source address and determining that these values do not match, the discovery agent manager 351 may determine that network address translation has occurred at an intermediate router, such as computing object 305a-3, along the network path. This bidirectional comparison approach enables detection of network address translation that would otherwise be invisible to single-perspective network scanning tools.

The discovery agent manager 351 may identify, from the first trace-route type sequence, first one or more intermediate hops between the first device and the router, and, from the second trace-route type sequence, second one or more intermediate hops between the second device and the router. The discovery agent manager 351 may identify the intermediate hops by extracting or parsing trace-route sequence information received from the discovery agent instances. For example, when a first discovery agent instance transmits probes with successively varied time-to-live values toward a second discovery agent instance, each intermediate computing object along the network path decrements the time-to-live value and, upon the value reaching zero, returns an ICMP Time Exceeded message containing the address of that intermediate computing object. The discovery agent manager 351 may parse these response messages to extract the addresses of the computing objects that the probes communicated with en route to the destination discovery agent instance.

For instance, the discovery agent manager 351 may extract from the first trace-route type sequence a first address corresponding to a first intermediate hop, a second address corresponding to a second intermediate hop, and additional addresses corresponding to subsequent intermediate hops, thereby identifying each intermediate hop between the first discovery agent instance and the second discovery agent instance. The discovery agent manager 351 may similarly parse the second trace-route type sequence transmitted from the second discovery agent instance toward the first discovery agent instance to extract addresses of intermediate computing objects traversed in the reverse direction. As illustrated in FIG. 4A, the discovery agent manager 351 may identify hop 404a (between computing object 305a-1 and computing object 305a-2) and hop 404b (between computing object 305a-2 and computing object 305a-3) as the first one or more intermediate hops from the first trace-route type sequence transmitted by discovery agent instance 402a. Similarly, the discovery agent manager 351 may identify hop 404d (between computing object 305a-5 and computing object 305a-4) and hop 404c (between computing object 305a-4 and computing object 305a-3) as the second one or more intermediate hops from the second trace-route type sequence transmitted by discovery agent instance 402b.

The discovery agent manager 351 may generate a network topology for the computing environment based at least on the first one or more intermediate hops, the router (e.g., computing object 305a-3 performing network address translation), and the second one or more intermediate hops. A network topology is a representation of how devices in a network are arranged and connected to one another, showing the paths through which data can flow between devices. The network topology may be implemented as a data structure stored in the memory 312 of the data processing system 306, such as a graph data structure, an adjacency list, an adjacency matrix, a tree structure, or other data structure suitable for representing network connectivity relationships. The network topology data structure may include node entries corresponding to each discovered device and edge entries corresponding to network connections between devices, where each node entry stores device attributes such as network addresses, device identifiers, device types, and network address translation mappings, and each edge entry stores connection attributes such as hop sequence positions, latency measurements, and interface identifiers.

To generate the network topology, the discovery agent manager 351 combines the intermediate hop information obtained from both trace-route type sequences. The first trace-route type sequence reveals the path from the first device toward the router, identifying each intermediate device along that portion of the network. The second trace-route type sequence reveals the path from the second device toward the same router, identifying intermediate devices on the opposite side of the network address translation boundary. The discovery agent manager 351 may parse the response messages from each trace-route type sequence to extract device addresses and hop positions, then construct node entries in the network topology data structure for each unique device address identified. For each consecutive pair of devices in the hop sequences, the discovery agent manager 351 may generate edge entries representing the network connections between those devices. By merging these two sets of intermediate hops with the identified router as the connection point, the discovery agent manager 351 constructs a complete representation of the network path that spans both sides of the NAT boundary. The discovery agent manager 351 may store the generated network topology data structure in the system data 350 or the graph database 344, enabling subsequent retrieval and processing by other components of the data processing system 306 such as the graph generator 328.

In some embodiments, the discovery agent manager 351 may retrieve a routing table from the router identified from the first one or more probes or the second one or more probes. A routing table is a data structure stored in a router that contains entries specifying how to forward packets to various network destinations, including destination network prefixes, next-hop addresses, interface identifiers, and routing metrics. For example, the discovery agent manager 351 may retrieve a routing table from computing object 305a-3 (e.g., the router performing network address translation) identified through the trace-route type sequences. The discovery agent manager 351 may retrieve the routing table by transmitting a management protocol request to the router, such as a Simple Network Management Protocol (SNMP) query, a Secure Shell (SSH) command, or an application programming interface (API) call, and receiving the routing table entries in response. The discovery agent manager 351 may generate the network topology based at least on the routing table in combination with the first one or more intermediate hops and the second one or more intermediate hops. For example, the discovery agent manager 351 may analyze the routing table entries to identify additional network segments, subnets, or connected interfaces that may not have been directly traversed by the probe sequences but are reachable through the router. The discovery agent manager 351 may augment the network topology data structure by adding node entries for devices indicated in the routing table entries and edge entries representing the routing relationships specified by the next-hop addresses and interface identifiers. By combining the routing table information with the intermediate hop data obtained from the bidirectional probe sequences, the discovery agent manager 351 generates a comprehensive network topology that includes both actively probed paths and configured routing relationships.

In some embodiments, the discovery agent manager 351 may identify the location of the router performing network address translation within the computing environment 304a and incorporate this location information into the generated network topology. For example, referring to FIG. 4A, computing objects 305a-1 and 305a-2 may reside within a private network segment while computing objects 305a-4 and 305a-5 may reside within a public network segment, with computing object 305a-3 operating as the router performing network address translation between the two segments. When the discovery agent instance 402a on computing object 305a-1 transmits probes toward the discovery agent instance 402b on computing object 305a-5, the discovery agent manager 351 may observe that the source address changes at computing object 305a-3, indicating that computing object 305a-3 is the NAT boundary router. The discovery agent manager 351 may determine the router location by correlating the point at which the address translation occurs with the intermediate hop sequence, identifying that computing object 305a-3 is positioned between hop 404b and hop 404c in the network path. The discovery agent manager 351 may incorporate this router location information into the network topology data structure by annotating the node entry for computing object 305a-3 with a NAT boundary indicator and by classifying the intermediate hops on each side of the router according to their respective network segments. For instance, the discovery agent manager 351 may annotate hop 404a and hop 404b as belonging to the private network segment and hop 404c and hop 404d as belonging to the public network segment. This approach enables the system to obtain visibility into the private addressing scheme and the intermediate hops that would otherwise be undetectable from external scanning tools operating solely within the public network, as such tools cannot observe devices behind the NAT boundary due to the address translation performed by the router before data packets leave the private network.

In some embodiments, the discovery agent manager 351 may generate the network topology by addressing one conflict between the network topology generated from the first one or more intermediate hops and the second one or more intermediate hops and the routing table by providing priority to the first one or more intermediate hops and the second one or more intermediate hops. For example, a conflict may occur when the routing table indicates a direct path between computing object 305a-2 and computing object 305a-4 but the probe sequences reveal that computing object 305a-3 is an intermediate hop between them. As another example, a conflict may arise when the routing table specifies a particular next-hop address that differs from the intermediate device address observed in the trace-route responses. Such conflicts arise because routing tables represent configured routing policies that may not accurately reflect current traffic flow patterns due to load balancing, policy-based routing, asymmetric routing configurations, or network changes that have not been updated in the routing table entries. Providing priority to the first one or more intermediate hops and the second one or more intermediate hops may include the discovery agent manager 351 constructing the network topology data structure using the hop sequence identified from the actual probe transmissions rather than the path indicated by the routing table entries when the two sources of information conflict. For instance, when the discovery agent manager 351 detects that the routing table indicates a direct connection but the probe sequences reveal an intermediate device, the discovery agent manager 351 may include the intermediate device in the network topology data structure and generate edge entries reflecting the actual observed path. By prioritizing the intermediate hops identified from the trace-route type sequences, the discovery agent manager 351 generates a network topology that accurately represents the actual communication paths traversed by network traffic within the computing environment 304a.

In some embodiments, the discovery agent manager 351 may map a changed network address observed in a header of a received probe to a corresponding original network address transmitted by the first instance or the second instance. For example, when the discovery agent manager 351 detects that the source address 192.168.1.10 transmitted by discovery agent instance 402a was rewritten to 203.0.113.50 as received by discovery agent instance 402b, the discovery agent manager 351 may create a mapping between these addresses indicating they correspond to the same device (e.g., computing object 305a-1). The discovery agent manager 351 may store the mapping in a translation mapping table or within the node entry of the network topology data structure, where the mapping associates the original network address with the translated network address and identifies the router at which the translation occurred. The discovery agent manager 351 may represent the mapped addresses as a single device within the generated network topology. For example, rather than creating separate node entries for address 192.168.1.10 and address 203.0.113.50, the discovery agent manager 351 may create a single node entry that stores both addresses as attributes of the same device, with an indication that one address is the internal address and the other is the translated external address. This mapping approach prevents the network topology from incorrectly representing a single device as multiple distinct devices due to address translation effects, thereby improving the accuracy of the generated network topology compared to existing systems that lack mechanisms to correlate translated addresses. The discovery agent manager 351 may apply the same mapping approach to source port translations, storing both the original source port and the translated source port within the same node entry when port address translation is detected.

In some embodiments, the discovery agent manager 351 may capture one or more network packets at least one of the first device or the second device, the captured one or more network packets not addressed to the device at which the one or more network packets were captured. Capturing network packets not addressed to the capturing device allows the system to observe traffic flowing through the network segment and identify devices that may not respond to direct probing. For example, the discovery agent instance 402a on computing object 305a-1 may capture network packets traversing the network segment that are destined for other devices within the computing environment 304a. The discovery agent manager 351 may identify a destination address of the one or more network packets. For instance, the discovery agent instance 402a may capture a packet with a destination address corresponding to a device not previously identified through the trace-route type sequences. The discovery agent manager 351 may update the network topology to include a link between the device at which the one or more network packets were captured and the destination address. In some embodiments, the discovery agent manager 351 may update a graph data structure (e.g., the main-graph 346) based on the updated network topology, thereby incorporating the newly identified devices and network connections into the graph data structure for subsequent processing by the graph neural network 332. By capturing and analyzing network packets not addressed to the capturing device, the discovery agent manager 351 can identify additional devices and network connections that may not respond to active probing, such as devices configured to drop ICMP packets or transparent network appliances.

In some embodiments, after generating the network topology, the system may generate a graph data structure to generate one or more remedial actions to cybersecurity vulnerabilities. For example, referring back to FIG. 3A, the system may generate one or more remedial actions to cybersecurity vulnerabilities based on a graph data structure to enhance the cybersecurity posture of the computing environment. The graph generator 328 may generate, using the network topology, a graph data structure comprising a first set of nodes corresponding to controls or requirements of one or more network security frameworks and a second set of nodes corresponding to different devices of the network topology. For instance, the graph generator 328 may receive the network topology generated by the discovery agent manager 351 and generate the graph data structure (e.g., graph data structure 348 or main-graph 346) by generating nodes representing each device represented in the network topology.

As illustrated in FIG. 4A, the graph generator 328 may generate object nodes corresponding to computing objects 305a-1, 305a-2, 305a-3, 305a-4, and 305a-5 identified through the network discovery operations. The graph generator 328 may further generate first edges between first pairs of the nodes represented based on the first one or more intermediate hops between the first device and the router and second edges between second pairs of the nodes represented based on the second one or more intermediate hops between the second device and the router. For example, the graph generator 328 may generate an edge between the node representing computing object 305a-1 and the node representing computing object 305a-2 based on hop 404a, and an edge between the node representing computing object 305a-2 and the node representing computing object 305a-3 based on hop 404b. Similarly, the graph generator 328 may generate an edge between the node representing computing object 305a-5 and the node representing computing object 305a-4 based on hop 404d, and an edge between the node representing computing object 305a-4 and the node representing computing object 305a-3 based on hop 404c. The graph generator 328 may further generate edges connecting the first set of nodes corresponding to controls or requirements of the one or more network security frameworks to the second set of nodes corresponding to the different devices of the network topology. For example, the graph generator 328 may generate an edge between a framework node 352a representing a network security framework control and an object node 354a representing computing object 305a-3 (e.g., the router performing network address translation) when the graph generator 328 determines that the control or requirement is applicable to the computing object based on corresponding identifiers, type classifications, or function categories. The discovery agent manager 351 may update the graph data structure based on the updated network topology, ensuring that the graph data structure accurately reflects the current network structure including any newly discovered devices or connections.

In some embodiments, the data processing system 306 may generate, using edges between the first and second sets of nodes of the graph data structure, a remedial action for addressing security risk from a network security framework of a device within the computing environment. For example, the data processing system 306 may analyze the edges connecting the first set of nodes (e.g., nodes corresponding to controls or requirements of one or more network security frameworks) to the second set of nodes (e.g., nodes corresponding to different devices of the network topology) to identify compliance gaps, security vulnerabilities, or missing relationships between network security framework controls and the discovered devices. The data processing system 306 may generate the remedial action based on the identified gaps or vulnerabilities, where the remedial action specifies configuration changes, security control adjustments, or software updates to be applied to devices identified through the network discovery operations.

In some embodiments, the data processing system 306 may generate the remedial action by executing the graph neural network 332 (shown in FIG. 3A), using the graph data structure to infer one or more relationships represented by the edges between the first set of nodes and the second set of nodes. The graph neural network 332 may receive the graph data structure as input and analyze the edges between the framework nodes 352 (e.g., nodes corresponding to controls or requirements of network security frameworks) and the object nodes 354 (e.g., nodes corresponding to devices identified through the network discovery operations) to identify compliance gaps, security vulnerabilities, or missing relationships between network security framework controls and the discovered devices. The graph neural network 332 may generate graph outputs including candidate remedial actions and confidence scores, and the generator 322 may process the graph outputs along with retrieved portions of electronic documents corresponding to network security frameworks to generate a refined remedial action.

Additionally or alternatively, the data processing system 306 may generate a subgraph from the graph data structure based on a user query or input and generate the remedial action using the subgraph. For example, a user may interact with a user interface presented on the client device 302 to submit a natural language query requesting information about network security frameworks as related to devices within the computing environment 304a. The user may submit a query such as “What NIST SP 800-53 controls apply to the router performing NAT in my network, and what remedial actions are needed to address any compliance gaps?” In response to receiving the user request, the encoder 318 may generate an embedding of the query and transmit the embedding to the retriever 320. The retriever 320 may perform a similarity search against the vector database 342 to identify embeddings of electronic document portions corresponding to applicable network security frameworks. The graph data retriever 330 may query the graph data structure (e.g., the main-graph 346) using the identified embeddings to identify a subset of the first set of nodes corresponding to applicable controls or requirements of network security frameworks.

The graph generator 328 may generate the subgraph from the identified subset of the first set of nodes that correspond to the controls or requirements of the security frameworks applicable to the computing environment and a subset of the second set of nodes linked by edges with the first set of nodes representing devices of the computing environment. For example, the subgraph may include framework nodes 352 corresponding to NIST SP 800-53 access control requirements and object nodes 354 corresponding to devices identified through the network discovery operations, such as computing objects 305a-1 through 305a-5. The subgraph preserves the edges and relationship information between the extracted nodes, including network connectivity relationships derived from the network topology generated by the discovery agent manager 351. The edges within the subgraph may include network topology information such as hop sequence data indicating the intermediate hops between connected computing objects, network address translation boundary information indicating whether the relationship spans a NAT boundary, and device connectivity relationships identified through the bidirectional probing operations performed by the discovery agent instances 402a and 402b. The graph neural network 332 may receive the subgraph as input and identify that computing object 305a-3 (e.g., the router performing network address translation) lacks an edge to a NIST SP 800-53 access control requirement node, indicating a compliance gap that requires remediation.

The remedial action may specify configuration changes to be applied to devices identified through the network discovery operations, such as updating firewall rules on computing object 305a-3 to implement access control requirements or enabling logging on computing object 305a-2 to satisfy audit requirements. The data processing system 306 may present an indication of the remedial action at the client device 302 on the user interface, enabling the user to review the recommended actions. In some embodiments, the action facilitator 338 may automatically implement the remedial action within the computing environment 304a to reduce cybersecurity risk within the computing environment. For example, the action facilitator 338 may communicate with the applicable computing objects 305a-1 through 305a-5 via the communication interface 308 to retrieve configuration profiles, modify the retrieved data according to the specifications identified in the remedial action, and transmit the modified data back to the appropriate computing object to be implemented. By integrating the accurate network topology generated through the coordinated bidirectional probing operations with the graph-based compliance analysis, the data processing system 306 generates remedial actions that account for the actual network structure of the computing environment, including devices hidden behind NAT boundaries and intermediate network devices that may not respond to standard probes, thereby improving the cybersecurity posture of the computing environment prior to a cybersecurity attack.

FIG. 4B illustrates an example flowchart of a process for facilitating remedial actions to cybersecurity vulnerabilities based on enhanced discovery of network devices within computing environments, in accordance with an implementation. A data processing system (e.g., the data processing system 306, shown and described with reference to FIG. 3A and/or subsystem 400, shown and described with reference to FIG. 4A) can perform the process 450 to facilitate remedial actions to cybersecurity vulnerabilities based on enhanced discovery of network devices within computing environments. The process 450 can include any number of operations or additional operations and the operations may be performed in any order.

At operation 452, the data processing system can execute a first instance of a network discovery agent on a first device of a computing environment to transmit first one or more probes to a second instance of the network discovery agent on a second device of the computing environment. The first one or more probes may comprise a first trace-route type sequence and include a first network address of the first device.

At operation 454, the data processing system can execute a second instance of the network discovery agent on the second device to transmit second one or more probes to the first instance of the network discovery agent on the first device. The second one or more probes may comprise a second trace-route type sequence and include a second network address of the second device.

The data processing system may execute the first instance of the network discovery agent on the first device to transmit a first message to the second instance of the network discovery agent and execute the second instance of the network discovery agent on the second device to transmit a second message to the first instance of the network discovery agent. The data processing system may execute the first instance of the network discovery agent on the first device to transmit the first one or more probes to the second instance of the network discovery agent on the second device in response to determining the second instance of the network discovery agent received the first message and the first instance of the network discovery agent received the second message. The first trace-route type sequence and the second trace-route type sequence may each comprise transmitting a plurality of probes having successively varied time-to-live values to elicit responses from intermediate hops. The data processing system may identify the intermediate hops based on addresses included in the responses.

At operation 456, the data processing system can determine a network address translation at a router between the first device and the second device based at least on a change in the first network address received in a header of a first probe at the second device or the second network address received in a header of a second probe at the first device. The data processing system may determine the network address translation by comparing at least one header field of the first probe as transmitted by the first device to a corresponding header field of the first probe as received at the second device, the header field comprising at least one of a source address or a source port. The data processing system may determine the network address translation in response to determining the comparison indicating the compared header fields do not match.

At operation 458, the data processing system can identify, from the first trace-route type sequence, first one or more intermediate hops between the first device and the router, and, from the second trace-route type sequence, second one or more intermediate hops between the second device and the router.

At operation 460, the data processing system can generate a network topology for the computing environment based at least on the first one or more intermediate hops, the router, and the second one or more intermediate hops. The data processing system may retrieve a routing table from the router identified from the first one or more probes or the second one or more probes. The data processing system may generate the network topology based at least on the routing table in combination with the first one or more intermediate hops and the second one or more intermediate hops.

As another example, the data processing system may generate the network topology by addressing one conflict between the network topology generated from the first one or more intermediate hops and the second one or more intermediate hops and the routing table by providing priority to the first one or more intermediate hops and the second one or more intermediate hops.

The data processing system may also map a changed network address observed in a header of a received probe to a corresponding original network address transmitted by the first instance or the second instance. The data processing system may then represent the mapped addresses as a single device within the generated network topology.

At operation 462, the data processing system can generate, using the network topology, a graph data structure comprising a first set of nodes corresponding to controls or requirements of one or more network security frameworks and a second set of nodes corresponding to different devices of the network topology. For example, the data processing system may generate the graph data structure using the network topology by generating nodes representing each device represented in the network topology. Moreover, the data processing system may generate first edges between first pairs of the nodes represented based on the first one or more intermediate hops between the first device and the router and second edges between second pairs of the nodes represented based on the second one or more intermediate hops between the second device and the router.

At operation 464, the data processing system can generate, using edges between the first and second sets of nodes of the graph data structure, a remedial action for addressing security risk from a network security framework of a device within the computing environment. As an example, the data processing system may generate the remedial action by executing a graph neural network, using the graph data structure to infer one or more relationships represented by the edges between the first set of nodes and the second set of nodes.

Additionally, the data processing system may capture one or more network packets at least one of the first device or the second device, the captured one or more network packets not addressed to the device at which the one or more network packets were captured. The data processing system may identify a destination address of the one or more network packets. The data processing system may update the network topology to include a link between the device at which the one or more network packets were captured and the destination address. The data processing system may update the graph data structure based on the updated network topology.

What is claimed is:

1. A system, comprising:
memory; and
one or more processors configured by machine-readable instructions stored in the memory to:
execute a first instance of a network discovery agent on a first device of a computing environment to transmit first one or more probes to a second instance of the network discovery agent on a second device of the computing environment, the first one or more probes comprising a first trace-route type sequence and including a first network address of the first device;
execute a second instance of the network discovery agent on the second device to transmit second one or more probes to the first instance of the network discovery agent on the first device, the second one or more probes comprising a second trace-route type sequence and including a second network address of the second device;
determine a network address translation at a router between the first device and the second device based at least on a change in the first network address received in a header of a first probe at the second device or the second network address received in a header of a second probe at the first device;
identify, from the first trace-route type sequence, first one or more intermediate hops between the first device and the router, and, from the second trace-route type sequence, second one or more intermediate hops between the second device and the router;
generate a network topology for the computing environment based at least on the first one or more intermediate hops, the router, and the second one or more intermediate hops;
generate, using the network topology, a graph data structure comprising a first set of nodes corresponding to controls or requirements of one or more network security frameworks and a second set of nodes corresponding to different devices of the network topology; and
generate, using edges between the first and second sets of nodes of the graph data structure, a remedial action for addressing security risk from a network security framework of a device within the computing environment.

2. The system of claim 1, wherein the one or more processors are further configured to:
execute the first instance of the network discovery agent on the first device to transmit a first message to the second instance of the network discovery agent and execute the second instance of the network discovery agent on the second device to transmit a second message to the first instance of the network discovery agent,
wherein the one or more processors are configured to execute the first instance of the network discovery agent on the first device to transmit the first one or more probes to the second instance of the network discovery agent on the second device in response to determining the second instance of the network discovery agent received the first message and the first instance of the network discovery agent received the second message.

3. The system of claim 1, wherein the one or more processors are further configured to:
retrieve a routing table from the router identified from the first one or more probes or the second one or more probes, and
generate the network topology based at least on the routing table in combination with the first one or more intermediate hops and the second one or more intermediate hops.

4. The system of claim 3, wherein the one or more processors are configured to generate the network topology by addressing one conflict between the network topology generated from the first one or more intermediate hops and the second one or more intermediate hops and the routing table by providing priority to the first one or more intermediate hops and the second one or more intermediate hops.

5. The system of claim 1, wherein the one or more processors are configured to generate the remedial action by:
executing a graph neural network, using the graph data structure to infer one or more relationships represented by the edges between the first set of nodes and the second set of nodes.

6. The system of claim 1, wherein the one or more processors are configured to determine the network address translation by:
comparing at least one header field of the first probe as transmitted by the first device to a corresponding header field of the first probe as received at the second device, the header field comprising at least one of a source address or a source port; and
determining the network address translation in response to determining the comparison indicating the compared header fields do not match.

7. The system of claim 1, wherein the first trace-route type sequence and the second trace-route type sequence each comprise transmitting a plurality of probes having successively varied time-to-live values to elicit responses from intermediate hops, and wherein the one or more processors are configured to identify the intermediate hops based on addresses included in the responses.

8. The system of claim 1, wherein the one or more processors are further configured to:
map a changed network address observed in a header of a received probe to a corresponding original network address transmitted by the first instance or the second instance, and
wherein the one or more processors are configured to represent the mapped addresses as a single device within the generated network topology.

9. The system of claim 1, wherein the one or more processors are further configured to:
capture one or more network packets at least one of the first device or the second device, the captured one or more network packets not addressed to the device at which the one or more network packets were captured;
identify a destination address of the one or more network packets;
update the network topology to include a link between the device at which the one or more network packets were captured and the destination address; and
update the graph data structure based on the updated network topology.

10. The system of claim 1, wherein the one or more processors are configured to generate the graph data structure using the network topology by:
generating nodes representing each device represented in the network topology; and
generating first edges between first pairs of the nodes represented based on the first one or more intermediate hops between the first device and the router and second edges between second pairs of the nodes represented based on the second one or more intermediate hops between the second device and the router.

11. A method, comprising:
executing, by one or more processors, a first instance of a network discovery agent on a first device of a computing environment to transmit first one or more probes to a second instance of the network discovery agent on a second device of the computing environment, the first one or more probes comprising a first trace-route type sequence and including a first network address of the first device;
executing, by the one or more processors, a second instance of the network discovery agent on the second device to transmit second one or more probes to the first instance of the network discovery agent on the first device, the second one or more probes comprising a second trace-route type sequence and including a second network address of the second device;
determining, by the one or more processors, a network address translation at a router between the first device and the second device based at least on a change in the first network address received in a header of a first probe at the second device or the second network address received in a header of a second probe at the first device;
identifying, by the one or more processors, from the first trace-route type sequence, first one or more intermediate hops between the first device and the router, and, from the second trace-route type sequence, second one or more intermediate hops between the second device and the router;
generating, by the one or more processors, a network topology for the computing environment based at least on the first one or more intermediate hops, the router, and the second one or more intermediate hops;
generating, by the one or more processors, using the network topology, a graph data structure comprising a first set of nodes corresponding to controls or requirements of one or more network security frameworks and a second set of nodes corresponding to different devices of the network topology; and
generating, by the one or more processors, using edges between the first and second sets of nodes of the graph data structure, a remedial action for addressing security risk from a network security framework of a device within the computing environment.

12. The method of claim 11, further comprising:
executing, by the one or more processors, the first instance of the network discovery agent on the first device to transmit a first message to the second instance of the network discovery agent and execute the second instance of the network discovery agent on the second device to transmit a second message to the first instance of the network discovery agent,
wherein executing, by the one or more processors, the first instance of the network discovery agent on the first device to transmit the first one or more probes to the second instance of the network discovery agent on the second device is in response to determining the second instance of the network discovery agent received the first message and the first instance of the network discovery agent received the second message.

13. The method of claim 11, further comprising:
retrieving, by the one or more processors, a routing table from the router identified from the first one or more probes or the second one or more probes, and
generating, by the one or more processors, the network topology based at least on the routing table in combination with the first one or more intermediate hops and the second one or more intermediate hops.

14. The method of claim 13, wherein generating the network topology further comprises:
addressing, by the one or more processors, one conflict between the network topology generated from the first one or more intermediate hops and the second one or more intermediate hops and the routing table by providing priority to the first one or more intermediate hops and the second one or more intermediate hops.

15. The method of claim 11, wherein generating the remedial action further comprises:
executing, by the one or more processors, a graph neural network, using the graph data structure to infer one or more relationships represented by the edges between the first set of nodes and the second set of nodes.

16. The method of claim 11, wherein determining the network address translation further comprises:
comparing, by the one or more processors, at least one header field of the first probe as transmitted by the first device to a corresponding header field of the first probe as received at the second device, the header field comprising at least one of a source address or a source port; and
determining, by the one or more processors, the network address translation in response to determining the comparison indicating the compared header fields do not match.

17. One or more non-transitory, computer-readable media, comprising instructions that, when executed by one or more processors, cause one or more operations comprising:
executing, a first instance of a network discovery agent on a first device of a computing environment to transmit first one or more probes to a second instance of the network discovery agent on a second device of the computing environment, the first one or more probes comprising a first trace-route type sequence and including a first network address of the first device;
executing, a second instance of the network discovery agent on the second device to transmit second one or more probes to the first instance of the network discovery agent on the first device, the second one or more probes comprising a second trace-route type sequence and including a second network address of the second device;
determining, a network address translation at a router between the first device and the second device based at least on a change in the first network address received in a header of a first probe at the second device or the second network address received in a header of a second probe at the first device;
identifying, from the first trace-route type sequence, first one or more intermediate hops between the first device and the router, and, from the second trace-route type sequence, second one or more intermediate hops between the second device and the router;
generating, a network topology for the computing environment based at least on the first one or more intermediate hops, the router, and the second one or more intermediate hops;
generating, using the network topology, a graph data structure comprising a first set of nodes corresponding to controls or requirements of one or more network security frameworks and a second set of nodes corresponding to different devices of the network topology; and
generating, using edges between the first and second sets of nodes of the graph data structure, a remedial action for addressing security risk from a network security framework of a device within the computing environment.

18. The computer-readable media of claim 17, wherein the instructions, that when executed by the one or more processors, further cause the one or more operations comprising:
executing the first instance of the network discovery agent on the first device to transmit a first message to the second instance of the network discovery agent and execute the second instance of the network discovery agent on the second device to transmit a second message to the first instance of the network discovery agent,
wherein executing the first instance of the network discovery agent on the first device to transmit the first one or more probes to the second instance of the network discovery agent on the second device is in response to determining the second instance of the network discovery agent received the first message and the first instance of the network discovery agent received the second message.

19. The computer-readable media of claim 17, wherein the instructions, that when executed by the one or more processors, further cause the one or more operations to generate the network topology comprising:
addressing one conflict between the network topology generated from the first one or more intermediate hops and the second one or more intermediate hops and a routing table by providing priority to the first one or more intermediate hops and the second one or more intermediate hops.

20. The computer-readable media of claim 17, wherein the instructions, that when executed by the one or more processors, further cause the one or more operations to generate the remedial action comprising:
executing, a graph neural network, using the graph data structure to infer one or more relationships represented by the edges between the first set of nodes and the second set of nodes.
